(19) United States
(12) Patent Application Publication
(10) Pub. No.: US 2012/0314955 A1
(43) Pub. Date: Dec. 13, 2012

(54) INFORMATION PROCESSING DEVICE, INFORMATION PROCESSING METHOD, AND PROGRAM

(75) Inventor: Koji OZAKI, Kanagawa (JP)

(73) Assignee: SONY CORPORATION, Tokyo (JP)

(21) Appl. No.: 13/440,458

(22) Filed: Apr. 5, 2012

(30) Foreign Application Priority Data
Jun. 7, 2011 (JP) 2011-127184

(51) Int. Cl. G06K 9/46

(52) U.S. Cl. 382/190

(57) ABSTRACT

An information processing device includes: an information processing unit that performs information processing sequentially using data with respect to each unit of processing, and obtains information processing results using a predetermined number of data in the order of processing with reference to data to be processed in the information processing of the data; and a data supplementation unit that extracts data contained in the predetermined number for obtaining the information processing result of the data of the next unit of processing to be subjected to the information processing and holds the data as supplementary data in the data with respect to each unit of processing supplied to the information processing unit, and allows the information processing unit to perform the information processing sequentially using the held supplementary data and the data of the next unit of processing to be subjected to the information processing.

### FIELD

The present technology relates to an information processing device, an information processing method, and a program. Specifically, the present technology relates to efficient performance of information processing using data as a processing object.

### BACKGROUND

Recently, in information processing of data to be processed, for example, in filter processing of image data, for reduction of the memory capacity necessary for the processing and the time taken for the processing without degradation of processing performance, an image is divided into a stripe pattern and filter processing is performed with respect to each of the divided image areas. For example, in Patent Document 1 (JP-A-2002-304624), an image is divided into a stripe pattern and two-dimensional filter processing is performed with respect to each of the divided image areas.

### SUMMARY

In the filter processing, pixel data for the number of taps is necessary for obtaining a filter processing result of one pixel. Therefore, in order to obtain a filter processing result of the divided image area, it is necessary to read out pixel data in a broader area than the divided image area from a memory in which pixel data is stored. Further, in the case where multistage filter processing is performed, a filter processing result may not be output unless pixel data for the number of taps has been output from the filter at the previous stage. Therefore, in the filter at the subsequent stage, a wait time is taken until the pixel data for the number of taps is output from the filter at the previous stage.

In Patent Document 1, when the unit of processing is shifted laterally, data is supplemented in the lateral direction and the order of the processing is first along the longitudinal direction, and then, along the lateral direction. When the unit of processing is shifted longitudinally, data is supplemented in the longitudinal direction and the order of the processing is first along the lateral direction, and then, along the longitudinal direction. However, in either case, a part needing a large internal memory is at the former stage and the internal memory proportional to input data is necessary. Therefore, in the case where a large internal memory is not provided, in size reduction, which is often used in an imaging apparatus, especially, only smaller output sizes may be provided, a series of filter processing should be repeated for the larger output sizes.

Accordingly, it is desirable to provide an information processing device, an information processing method, and a program that may efficiently perform information processing using data to be processed.

An embodiment of the present technology is directed to an information processing device including an information processing unit that performs information processing sequentially using data with respect to each unit of processing, and obtains information processing results using a predetermined number of data in the order of processing with reference to data to be processed in the information processing of the data, and a data supplementation unit that extracts data contained in the predetermined number for obtaining the information processing result of the data of the next unit of processing to be subjected to the information processing and holds the data as supplementary data in the data with respect to each unit of processing supplied to the information processing unit, and allows the information processing unit to perform the information processing sequentially using the held supplementary data and the data of the next unit of processing to be subjected to the information processing.

In the embodiment of the present technology, information processing is performed sequentially using data with respect to each unit of processing, for example, filter processing is performed sequentially using image data with respect to each unit of processing, and a predetermined number of pixel data in the order of processing with reference to pixel locations to be processed is used in the filter processing of the image data. Here, in the image data with respect to each unit of processing, pixel data contained in the predetermined number is extracted for obtaining the information processing result of the image data of the next unit of processing to be subjected to the information processing and held as supplementary data. Further, the supplementary data is extracted so that the information processing results for the units of processing may be obtained if the information processing is performed sequentially using the supplementary data and the image data of the next unit of processing to be subjected to the information processing. In the case where filter processing of image data is performed at multiple stages, for example, the supplementary data is extracted from the information processing result output from the first information processing unit, and the supplementary data is output to the second information processing unit at the next stage using a period until the processing result of the next unit of processing is output from the first information processing unit.

Further, in the memory from which image data is read out in units of processing, the image data to be subjected to information processing is shifted with respect to the locations of units of processing and stored so that the supplementary data may be provided after invalid data in the data of the first unit of processing. Furthermore, after the supplementary data is used for the filter processing of the next unit of processing, new pixel data is rewritten as supplementary data.

Another embodiment of the present technology is directed to an information processing method including performing information processing sequentially using data with respect to each unit of processing, and obtaining information processing results using a predetermined number of data in the order of processing with reference to data to be processed in the information processing of the data, and supplementing data by extracting data contained in the predetermined number for obtaining the information processing result of the data of the next unit of processing to be subjected to the information processing and holding the data as supplementary data in the data with respect to each unit of processing used in the information processing, and allows in the information processing to perform the information processing sequentially using the held supplementary data and the data of the next unit of processing to be subjected to the information processing.

Still another embodiment of the present technology is directed to a program allowing a computer to execute information processing, and includes an information processing procedure of performing information processing sequentially using data with respect to each unit of processing, and obtaining information processing results using a predetermined number of data in the order of processing with reference to data to be processed in the information processing of the data, and a data supplementing procedure of extracting data contained in the predetermined number for obtaining the information processing result of the data of the next unit of processing to be subjected to the information processing and holding the data as supplementary data in the data with respect to each unit of processing used in the information processing procedure, and allows in the information processing procedure to perform the information processing sequentially using the held supplementary data and the data of the next unit of processing to be subjected to the information processing.

Note that the program of the embodiment of the present technology is a program that may be provided by a storage medium or a communication medium that provides the program in a computer-readable form to a general-purpose computer system that can execute various program codes, for example, a storage medium such as an optical disc, a magnetic disc, or a semiconductor memory, or a communication medium such as a network. By providing the program in a computer-readable form, processing in response to the program is realized on the computer system.

According to the embodiments of the present technology, information processing is performed sequentially using data with respect to each unit of processing, and a predetermined number of data in the order of processing with reference to data to be processed is used in the information processing of the data. Further, the data contained in the predetermined number for obtaining the information processing result of the data of the next unit of processing to be subjected to the information processing is held as supplementary data, and information processing is performed sequentially using the held supplementary data and the data of the next unit of processing to be subjected to the information processing. Therefore, information processing using data to be processed may be performed with high efficiency.

### BRIEF DESCRIPTION OF THE DRAWINGS

FIG. 1 shows a configuration of an imaging apparatus.

FIG. 2 shows a first configuration of a camera signal processing section.

FIG. 3 shows a configuration of a data supplementation unit.

FIG. 4 is a flowchart showing an operation of an input control part in the data supplementation unit.

FIG. 5 is a flowchart showing an operation of an output control part in the data supplementation unit.

FIGS. 6A and 6B are diagrams for explanation of filter processing using pixel data of an area of 5×5 pixels.

FIGS. 7A and 7B show pixel locations having pixel data to be held.

FIGS. 8A and 8B show an image to be processed divided into units of processing.

FIG. 9 shows an image to be processed and units of processing as an example.

FIG. 10 shows a processing operation of the first unit of processing BL1.

FIG. 11 shows a processing operation of the second unit of processing BL2.

FIG. 12 shows a processing operation of the third unit of processing BL3.

FIG. 13 shows a processing operation of the last unit of processing BL4.

FIG. 14 shows a processing operation when a filter processing result of the last unit of processing BL4 is held.

FIG. 15 shows a configuration of a camera signal processing section in related art.

FIG. 16 shows a processing operation in related art.

FIGS. 17A and 17B show times of inputs of pixel data and outputs of pixel data after information processing.

FIGS. 18A to 18D show relationships between directions in which the unit of processing is shifted and areas to which supplementary data is input and areas output as supplementary data.

FIG. 19 shows a second configuration of the camera signal processing section.

FIGS. 20A to 20C show relationships between locations of units of processing and images.

FIG. 21 shows a size of an image to be processed.

FIG. 22 shows a processing operation of the first unit of processing BR1.

FIG. 23 shows a processing operation of the second unit of processing BR2.

FIG. 24 shows a processing operation of the third unit of processing BR3.

FIG. 25 shows a processing operation of the last unit of processing BR4.

FIG. 26 shows a processing operation of the first unit of processing when the unit of processing is doubled to an 8-pixel width.

FIG. 27 shows a processing operation of the second unit of processing when the unit of processing is doubled to the 8-pixel width.

FIG. 28 shows a configuration of a camera signal processing section in related art.

FIGS. 29A to 29C show relationships between locations of units of processing and images.

FIG. 30 shows a processing operation in related art.

FIGS. 31A and 31B show times of inputs of pixel data and outputs of pixel data after filter processing.

FIG. 32 shows a processing operation when a filter processing unit that performs filter processing only in the longitudinal direction is provided at the upstream of the data supplementation unit.

FIG. 33 shows an operation in combination of a first configuration operation and a second configuration operation.

FIGS. 34A to 34D show filter processing operations.

FIGS. 35A and 35B are diagrams for explanation of constrains of the order of filter processing in related art.

### DETAILED DESCRIPTION

Hereinafter, embodiments of the present technology will be explained. The explanation will be made in the following order.

1. Configuration of Imaging Apparatus

2. First Configuration of Camera Signal Processing Section

3. Configuration and Operation of Data Supplementation Unit

4. First Configuration Operation

5. Second Configuration of Camera Signal Processing Section

6. Second Configuration Operation

7. Operation in combination of First Configuration

### Operation and Second Configuration Operation

### <1. Configuration of Imaging Apparatus>

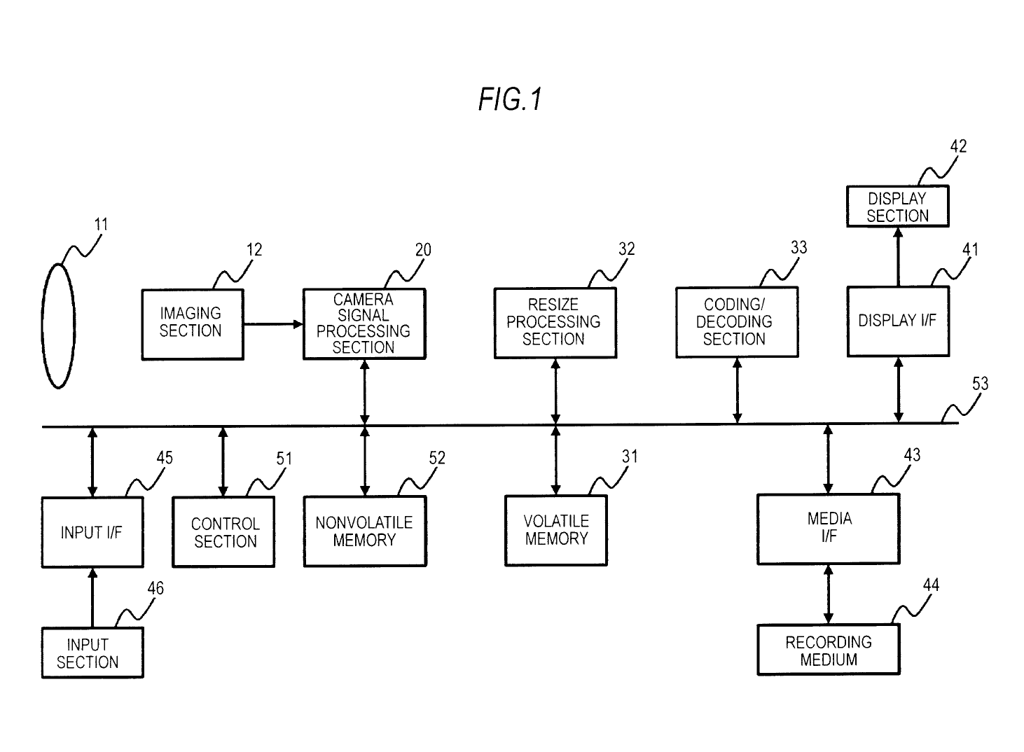

FIG. 1 shows a configuration of an imaging apparatus to which an information processing device according to the present technology is applied as an example. The imaging apparatus 10 includes an imaging lens section 11, an imaging section 12, a camera signal processing section 20, a volatile memory 31, a resize processing section 32, and a coding/decoding section 33. Further, the imaging apparatus 10 includes a display interface (I/F) 41, a display section 42, a media interface (I/F) 43, a recording medium 44, an input interface (I/F) 45, an input section 46, a control section 51, a nonvolatile memory 52, and a bus 53. To the bus 53, the camera signal processing section 20, the volatile memory 31, the resize processing section 32, the coding/decoding section 33, the display interface 41, the media interface 43, the input interface 45, the control section 51, etc. are connected.

The imaging lens section 11 functions as an imaging optical system for guiding object light to the imaging section 12. The imaging lens section 11 includes a focus lens for adjustment of focus of an optical image formed on an imaging surface of the imaging section 12, a zoom lens for scaling the optical image, etc.

The imaging section 12 includes a solid-state image sensing device such as a CMOS (Complementary Metal-Oxide Semiconductor) or a CCD (Charge Coupled Device). The imaging section 12 performs photoelectric conversion to generate an imaging signal in response to the optical image formed on a light receiving surface by the imaging lens section 11 and outputs it to the camera signal processing section 20.

The camera signal processing section 20 uses the volatile memory 31 as a working memory and performs preprocessing and development processing of the imaging signal. Further, the information processing device (information processing method) according to the present technology is applied to the camera signal processing section 20, and performs information processing using a predetermined number of data in the order of processing with reference to the data to be processed, for example, filter processing using data for the number of taps or the like. The details of the camera signal processing section 20 will be described later.

The volatile memory 31 is used as a working memory for various kinds of signal processing in the imaging apparatus 10. Further, the volatile memory 31 is also used as a temporary storage area for various kinds of information for desired operations in the imaging apparatus 10 or the like.

The resize processing section 32 reads out image data after camera signal processing stored in the volatile memory 31 and converts it into an image with desired resolution (number of pixels). For example, the resize processing section 32 converts image data subjected to the camera signal processing into image data in response to display resolution of the display section 42. Further, the resize processing section 32 converts resolution of image data into resolution instructed by a user for recording of the data in the recording medium 44. Furthermore, the section cuts out a partial area of the image and executes conversion processing of the resolution, and thereby, generates image data subjected to processing of electronic zoom or reproduction zoom.

The coding/decoding section 33 performs data compression processing of image data and stores the obtained coded data in the volatile memory 31. Further, the coding/decoding section 33 stores the coded data in the recording medium 44. Furthermore, the section performs decoding processing of the coded data stored in the recording medium 44 and the coded data stored in the volatile memory 31, and outputs the obtained image data to the volatile memory 31 or the display section 42 or the like via the display interface 41. To the coding/decoding processing, a method of JPEG (Joint Photographic Coding Experts Group) is applied for still images. Further, for moving images, a data compression method using motion vector such as MPEG1 (Motion Picture Experts Group 1), MPEG2 (Motion Picture Experts Group 2), MPEG4 (Motion Picture Experts Group 4) of ISO/IEC JTC1/SC29WG11, or H.263, H.264/MPEG4-AVC (Advanced Video Coding) of ITU-T is applied.

The display interface 41 supplies image data after resize processing read out from the volatile memory 31 etc. to the display section 42. Further, the display interface 41 supplies a display control signal generated in the control section 51, for example, for menu display for choices of functions of the imaging apparatus 10, set condition display showing the set condition of the imaging apparatus 10, or the like.

The display section 42 is formed using a planar display device of liquid crystal or organic EL. The display section 42 performs display of a monitor image at imaging operation, an image stored in the volatile memory 31, an image recorded in the recording medium 44, menu display, set condition display, etc. based on image data supplied via the display interface 41.

The media interface 43 is an interface for recording the data in and reading the recorded data from the recording medium 44. As the recording medium 44, a semiconductor memory card, a disc-shaped recording medium for recording and reproduction using magnetism or light, or the like is used.

The input section 46 is connected to the input interface 45. The input section 46 includes an operation switch, a touch panel, etc., and generates and outputs an operation signal in response to user operation to the control section 51 via the input interface 45.

The control section 51 includes a CPU (Central Processing Unit) etc. The control section 51 executes a program stored in the nonvolatile memory 52, for example, to generate control signals so that the operation of the imaging apparatus 10 may be an operation in response to the user operation, and supplies the signals to the respective sections via the bus 53. Note that the program is installed in the imaging apparatus 10 in advance and provided. Further, in place of provision by installation in advance, the program may be provided via a network such as the Internet, or provided using a recording medium.

### <2. First Configuration of Camera Signal Processing Section>

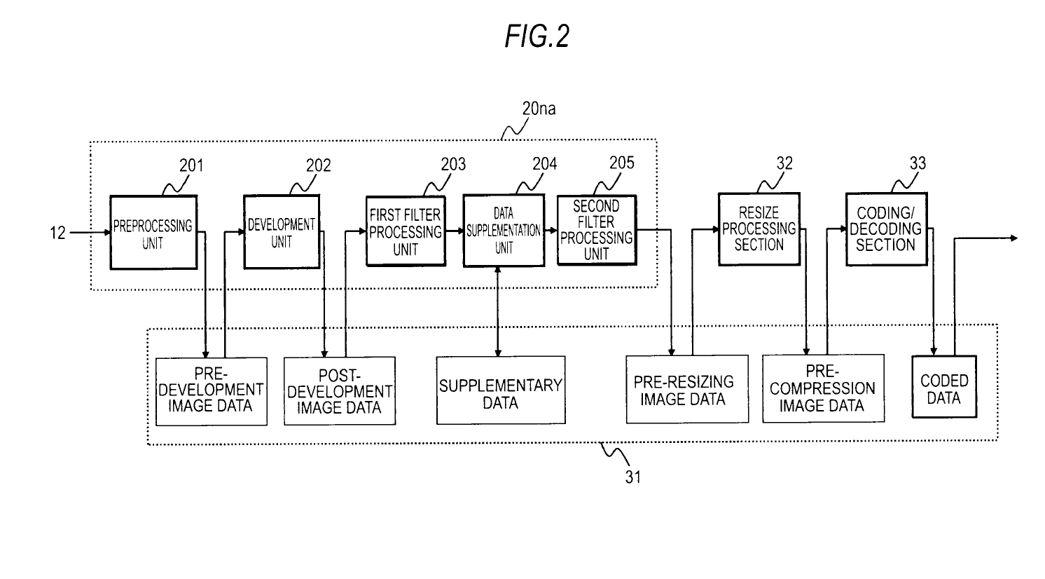

FIG. 2 shows a first configuration of the camera signal processing section. The camera signal processing section 20na includes a preprocessing unit 201, a development unit 202, a first filter processing unit 203, a data supplementation unit 204, and a second filter processing unit 205.

The preprocessing unit 201 performs preprocessing such as analog amplification processing and A/D conversion processing of the imaging signal supplied from the imaging section 12, and stores image data (pre-development image data) subjected to the preprocessing in the volatile memory 31. The development unit 202 reads out the pre-development image data, performs correction processing such as de-mosaic processing, brightness correction, color correction, and white balance adjustment as development processing, and stores post-development image data in the volatile memory 31.

In the camera signal processing section 20na, multistage filter processing is performed by the first filter processing unit 203 and the second filter processing unit 205. The first filter processing unit 203 is a denoising unit, for example, and reads out the post-development image data with respect to each unit of processing and performs band limitation thereon or the like, to eliminate noise components of the image data. The second filter processing unit 205 is a deblurring unit, for example, and performs filter processing of enhancing details, contour parts, or the like of the image using the image data after denoising to correct blur. The image data (pre-resizing image data) subjected to denoising and deblurring processing is stored in the volatile memory 31.

The data supplementation unit 204 stores the image data subjected to the filter processing in the first filter processing unit 203 and used when filter processing is performed with respect to each unit of processing in the second filter processing unit 205 in the volatile memory 31 as supplementary data. Further, the data supplementation unit 204 reads out the pixel data necessary when filter processing is performed with respect to each unit of processing in the second filter processing unit 205 from the volatile memory 31 and outputs the data to the second filter processing unit 205 as the supplementary data. Furthermore, the data supplementation unit 204 holds pixel data as supplementary data so that the output of the second filter processing unit 205 may be in the number of data of the unit of processing, for example.

The resize processing section 32 reads out the pre-resizing image data stored in the volatile memory 31 and performs processing of converting the data into an image with desired resolution (number of pixels) or the like. The resize processing section 32 stores post-resizing image data (pre-compression image data) in the volatile memory 31. The coding/decoding section 33 performs coding processing of the pre-compression data and stores the obtained coded data in the volatile memory 31.

### <3. Configuration and Operation of Data Supplementation Unit>

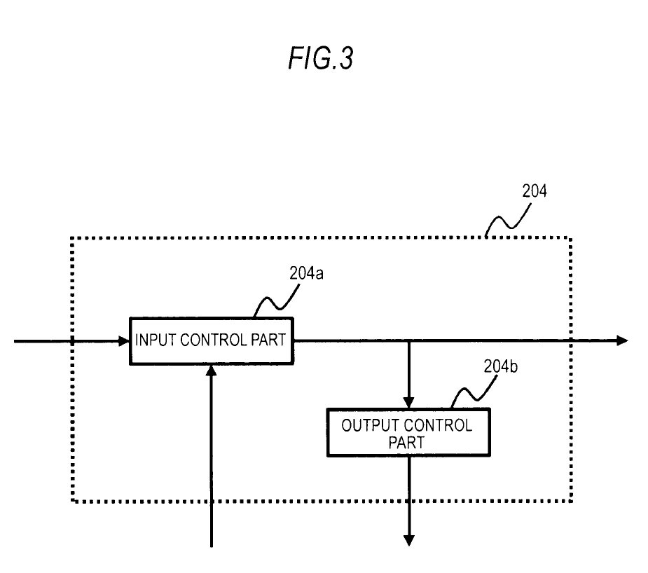

FIG. 3 shows a configuration of the data supplementation unit. The data supplementation unit 204 includes an input control part 204a and an output control part 204b. The input control part 204a outputs the data supplied from the first filter processing unit 203 to the output control part 204b and the second filter processing unit 205. Further, the input control part 204a reads out the supplementary data necessary when filter processing is performed with respect to each unit of processing in the second filter processing unit 205 from the volatile memory 31 and outputs the data to the second filter processing unit. The output control part 204b extracts and stores pixel data necessary when filter processing of the next unit of processing is performed in the second filter processing unit 205 in the volatile memory 31 as supplementary data.

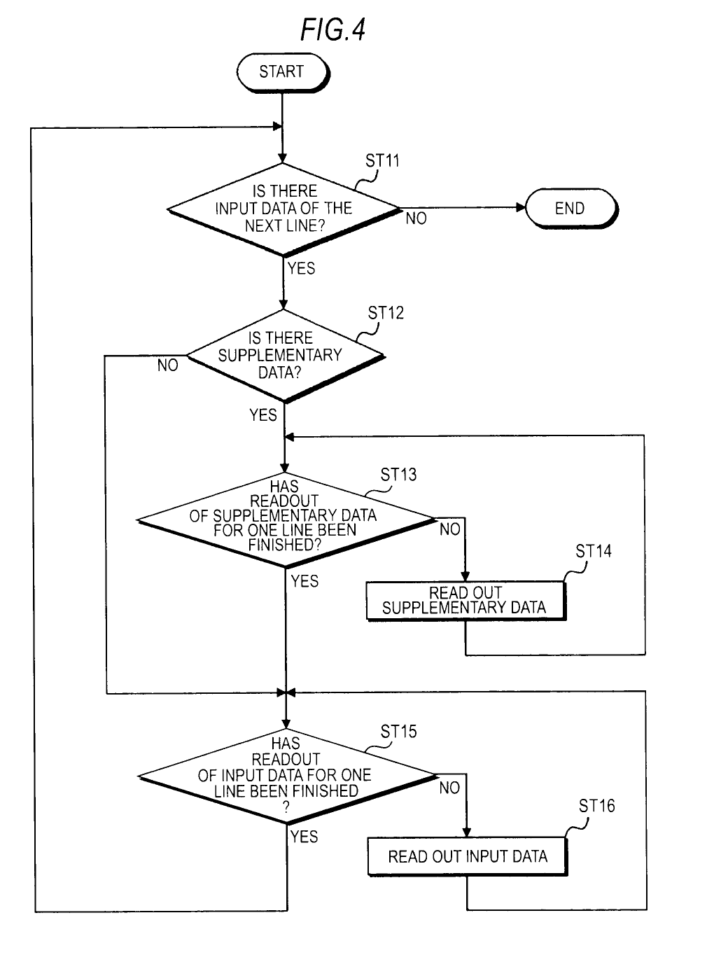

FIG. 4 is a flowchart showing an operation of the input control part in the data supplementation unit. At step ST11, the input control part 204a determines whether or not there is input data of the next line. The input control part 204a moves to step ST12 if there is input data of the next line and ends an operation of one unit of processing if there is not input data of the next line.

At step ST12, the input control part 204a determines whether or not there is supplementary data. The input control part 204a moves to step ST13 if supplementary data for an area of the unit of processing to be filter-processed is stored in the volatile memory 31, and moves to step ST15 if the data is not stored.

At step ST13, the input control part 204a determines whether or not readout of supplementary data for one line has been finished. The input control part 204a moves to step ST14 if readout of supplementary data for one line has not been finished, and moves to step ST15 if the readout has been finished.

At step ST14, the input control part 204a reads out the supplementary data and returns to step ST13.

At step ST15, the input control part 204a determines whether or not readout of input data for one line has been finished. The input control part 204a moves to step ST16 if readout of input data for one line has not been finished, and returns to step ST11 if the readout has been finished.

At step ST16, the input control part 204a reads out the input data and returns to step ST15.

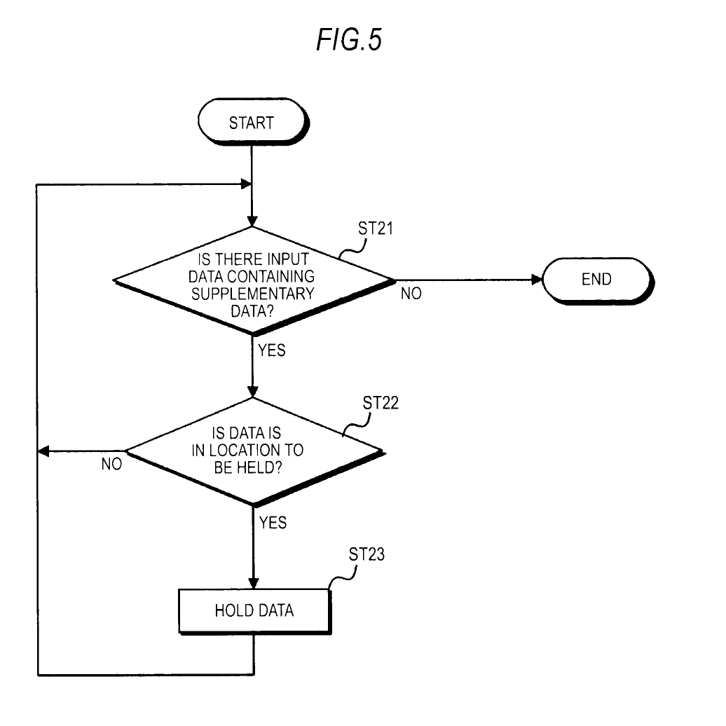

FIG. 5 is a flowchart showing an operation of the output control part in the data supplementation unit. At step S21, the output control part 204b determines whether or not there is input data containing supplementary data. The output control part 204b moves to step ST22 if there is input data containing pixel data necessary when filter processing is performed in the second filter processing unit, i.e., pixel data of the so-called margin area, and ends processing if there is not input data containing supplementary data.

At step S22, the output control part 204b determines whether or not the data is in a location to be held. The output control part 204b moves to step ST23 if the input data is data in a location of the margin area, and returns to step ST21 if the data is data not in the location of the margin area.

At step S23, the output control part 204b holds data. The output control part 204b holds the input data in the location of the margin area in the volatile memory 31 as supplementary data, and returns to step ST21.

When the above described processing is performed in the input control part 204a and the output control part 204b, the supplementary data of the margin area is added to the input data of the unit of processing with respect to each line, and output to the second filter processing unit. Further, in the input data, the pixel data in the location of the margin area in the next unit of processing is stored in the volatile memory 31 as supplementary data.

### <4. First Configuration Operation>

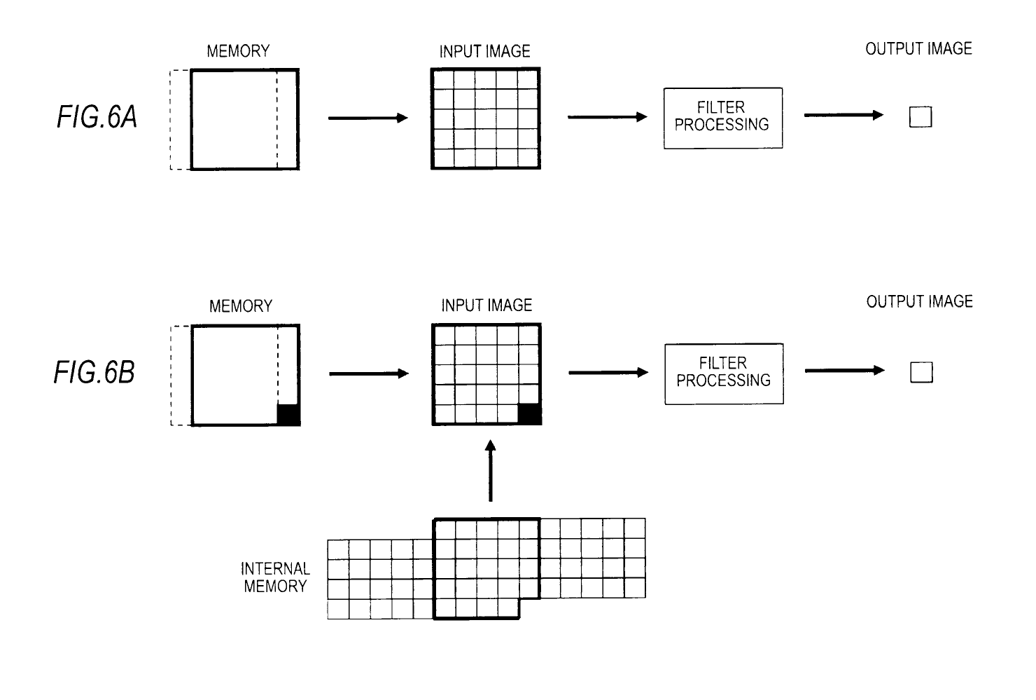

FIGS. 6A and 6B are diagrams for explanation of filter processing using pixel data of an area of 5×5 pixels. As shown in FIG. 6A, if the area of 5×5 pixels is sequentially shifted in units of pixels and pixel data is read out with respect to each location of the respective areas and filter operation is performed thereon, pixel data is repeatedly read out from many pixels. For example, in the case where filter operation is performed by reading out pixel data of the area shown by a dotted line, and then, pixel data in the area shown by a solid line, readout of the pixel data of overlapping areas is repeated. Accordingly, if the readout pixel data is held and the held pixel data is reused, the pixels from which readout of pixel data is performed may be reduced. FIG. 6B shows the case where the area of 5×5 pixels is sequentially shifted in units of pixels rightward. Pixel data for 24 pixels is stored in an internal memory, for example, and thus, filter processing may be performed only by reading out pixel data for one pixel in the lower right corner.

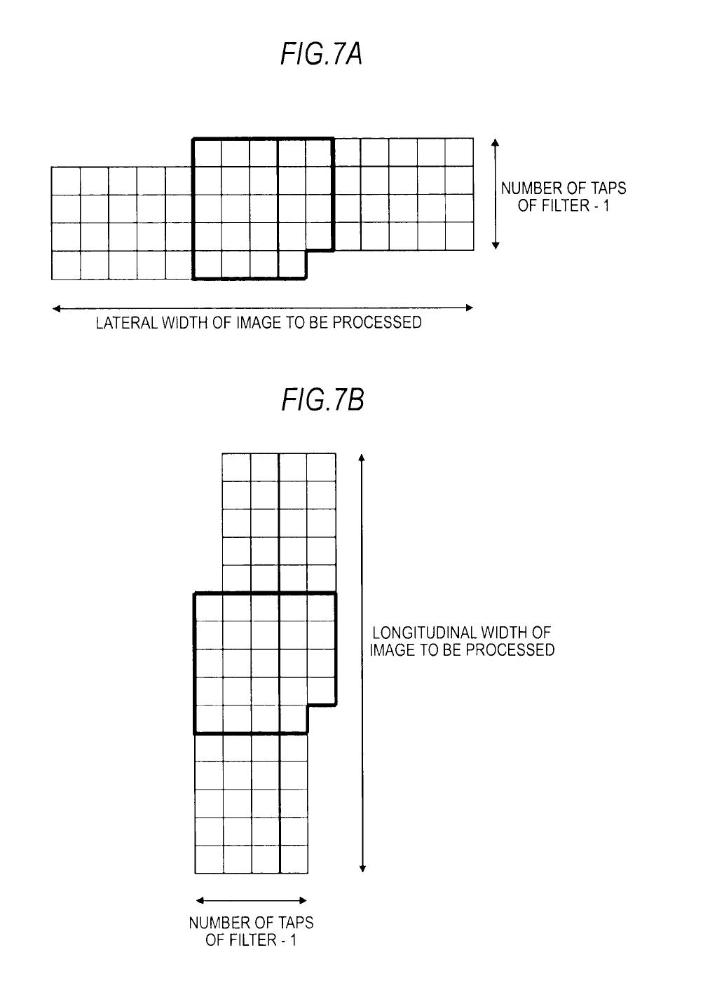

In the case where the read out pixel data is held, if the lateral width and longitudinal width of the image to be processed are larger, the pixel data to be held increases and an internal memory having larger capacity or the like is necessary. FIGS. 7A and 7B show pixel locations having pixel data to be held. For example, if the area of 5×5 pixels is shifted in the lateral direction, the pixel data of the pixel locations shown in FIG. 7A is held, and the pixel data of 24 pixels shown by a bold line is reused in filter operation. Further, for example, if the area of 5×5 pixels is shifted in the longitudinal direction, the pixel data of the pixel locations shown in FIG. 7B is held, and the pixel data of 24 pixels shown by a bold line is reused in filter operation. Note that, in the case where the area of 5×5 pixels is shifted by one pixel, in the area of 5×5 pixels used for filter operation, the pixel data in the upper left corner is deleted and the read out pixel data in the lower right corner is newly held.

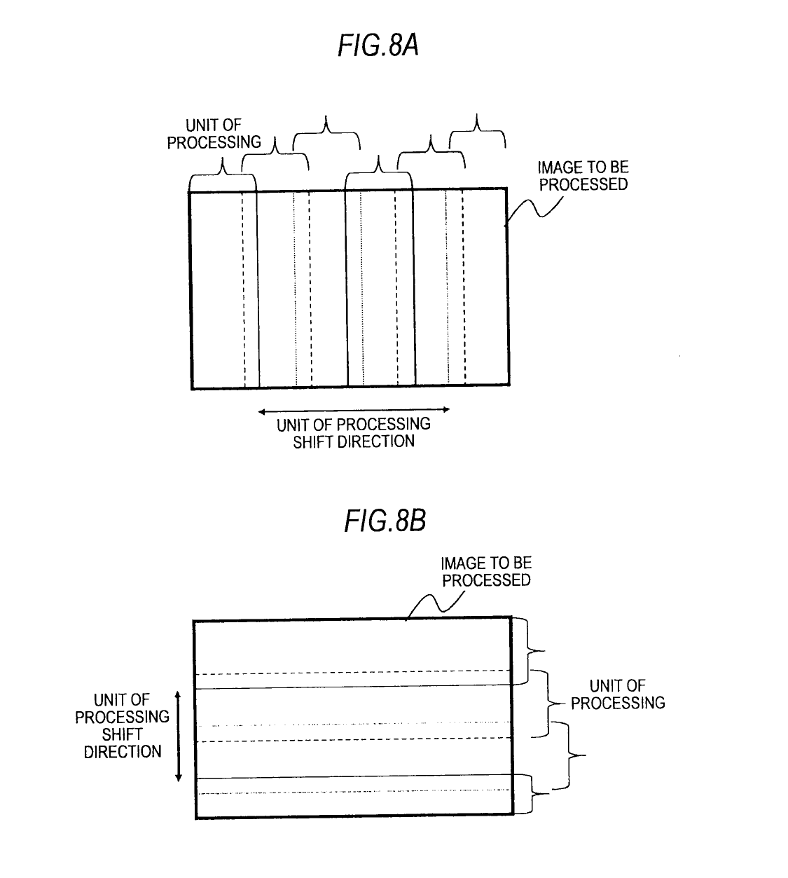

Thus, in the case where the read out pixel data is held, if the lateral width and longitudinal width of the whole image are larger, an internal memory having larger capacity or the like is necessary. Therefore, as shown in FIGS. 8A and 8B, an image to be processed is divided into plural units of processing in response to the shift direction of the area and processing is performed with respect to each unit of processing. For example, when the area is shifted in the lateral direction, the image to be processed is divided so that the lateral width of the unit of processing may be smaller as shown in FIG. 8A. Further, when the area is shifted in the longitudinal direction, the image to be processed is divided so that the longitudinal width of the unit of processing may be smaller as shown in FIG. 8B. Furthermore, in filter operation, pixel data for the number of taps is necessary. Therefore, for continuous filter operation between units of processing, in the division of the image, overlapping parts (margin areas) proportional to the number of taps are provided for division.

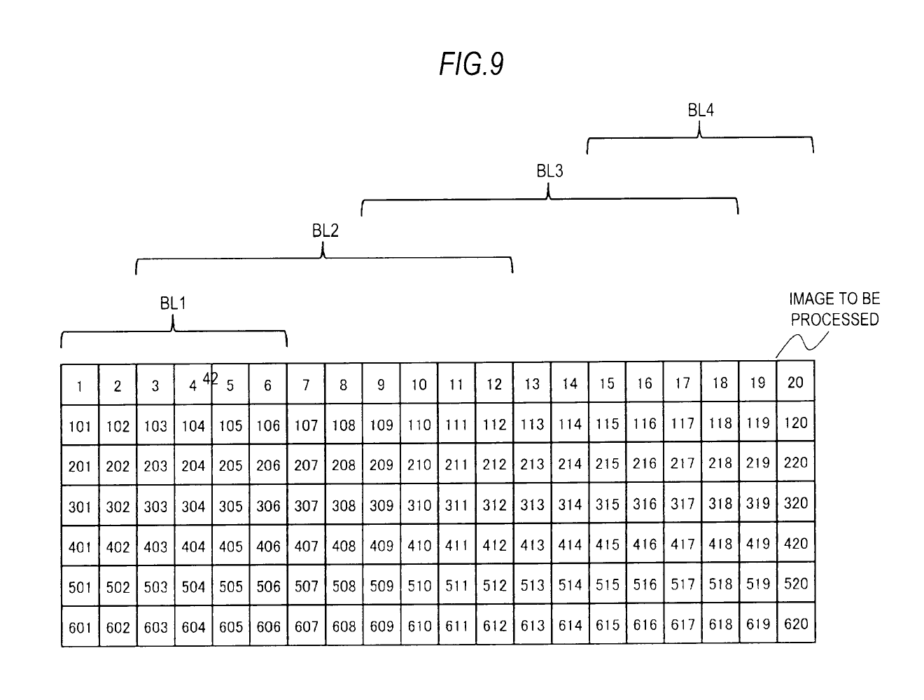

As below, the case where filter processing is performed when the unit of processing is a longitudinal area will be explained. Further, in the longitudinal area, the longitudinal size is the number of pixels in the longitudinal direction of the whole image. Furthermore, for simplicity of explanation, the image size is 20 pixels×7 pixels as shown in FIG. 9, for example. In addition, the number of taps of the first filter processing unit 203 and the second filter processing unit 205 is five and the units of processing are BL1 to BL4.

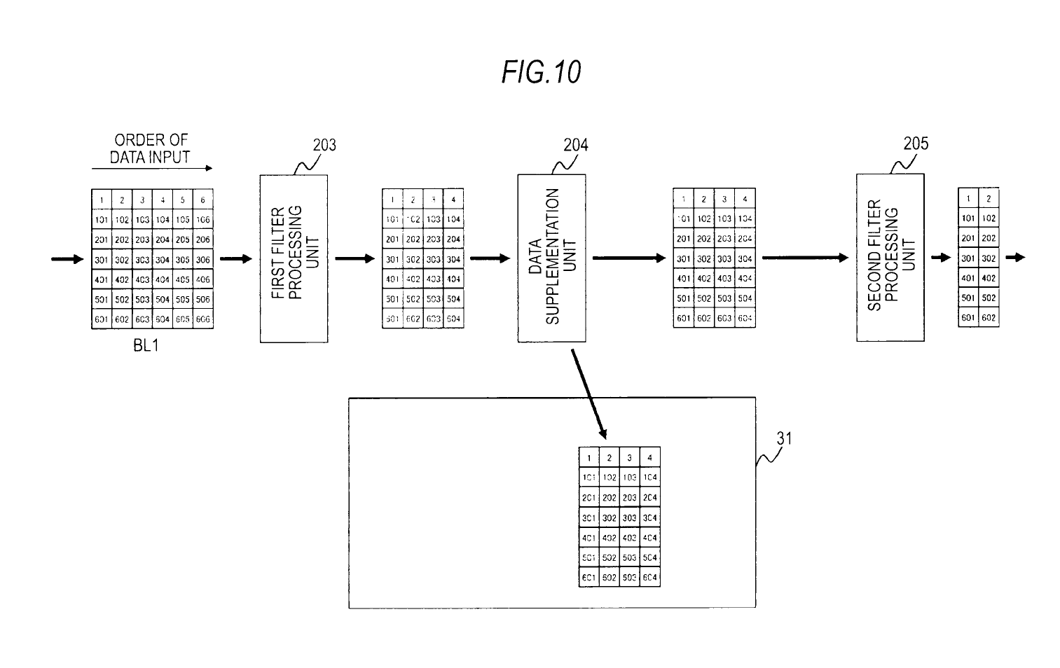

FIG. 10 shows a processing operation of the first unit of processing BL1. For example, pixel data of the first line, i.e., pixel data in pixel locations “1” to “6” is input to the first filter processing unit 203. In this case, the first filter processing unit 203 performs filter processing with five taps and outputs pixel data after first filter processing in the pixel locations “1” to “4”. Note that the pixel location “1” is a location at the image end, and the first filter processing unit 203 performs pixel repeat and performs filter operation by repeating pixel data of the image end for shortage of pixel data.

The data supplementation unit 204 performs the input control operation shown in FIG. 4 and the output control operation shown in FIG. 5. Here, in the first unit of processing BL1, no supplementary data is stored in the volatile memory 31. Therefore, the data supplementation unit 204 outputs pixel data after the first filter processing in the pixel locations “1” to “4” of the first line to the second filter processing unit 205.

The second filter processing unit 205 performs second filter processing using the pixel data after the first filter processing in the pixel locations “1” to “4” supplied from the data supplementation unit 204, and outputs pixel data subjected to the first and second filter processing in the pixel locations “1” and “2”.

Here, in the next unit of processing BL2, in order to output pixel data after the first and second filter processing in the pixel location “3” and the subsequent locations from the second filter processing unit 205, it is necessary to input pixel data after the first filter processing in the pixel location “1” and the subsequent locations to the second filter processing unit 205. Further, the pixel data after the first filter processing from the pixel location “1” is generated by filter processing of the first filter processing unit 203 for the first unit of processing BL1. Therefore, the data supplementation unit 204 stores the pixel data after the first filter processing in the pixel locations “1” to “4” in the volatile memory 31.

The first filter processing unit 203, the data supplementation unit 204, and the second filter processing unit 205 perform processing of the second line after the processing of the first line of the first unit of processing BL1 is finished. The first filter processing unit 203 performs filter processing using pixel data in pixel locations “101” to “106” of the second line, and outputs pixel data after first filter processing in the pixel locations “101” to “104”. Note that the pixel location “101” is a location at the pixel end, and the first filter processing unit 203 performs pixel repeat and performs filter operation by repeating pixel data of the image end for shortage of pixel data.

Since the supplementary data is not stored in the volatile memory 31 in the first unit of processing BL1, the data supplementation unit 204 outputs the pixel data after the first filter processing in the pixel locations “101” to “104” of the second line to the second filter processing unit 205.

The second filter processing unit 205 performs filter processing using the pixel data after the first filter processing in the pixel locations “101” to “104” supplied from the data supplementation unit 204, and outputs pixel data subjected to the first and second filter processing in the pixel locations “101” and “102”.

In the next unit of processing BL2, in order to output pixel data after the first and second filter processing in the pixel location “103” and the subsequent locations from the second filter processing unit 205, it is necessary to input pixel data after the first filter processing from the pixel location “101” to the second filter processing unit 205. Further, the pixel data after the first filter processing from the pixel location “101” is generated by filter processing of the first filter processing unit 203 for the first unit of processing BL1. Therefore, the data supplementation unit 204 stores the pixel data after the first filter processing in the pixel locations “101” to “104” in the volatile memory 31.

Subsequently, the same processing is performed with respect to each line of the unit of processing BL1, and the second filter processing unit 205 outputs pixel data subjected to the first and second filter processing in the pixel locations “201”, “202”, . . . , “601”, and “602”. Further, the data supplementation unit 204 stores the pixel data subjected to the first filter processing in the pixel locations “201” to “204”, . . . , “601” to “604” in the volatile memory 31.

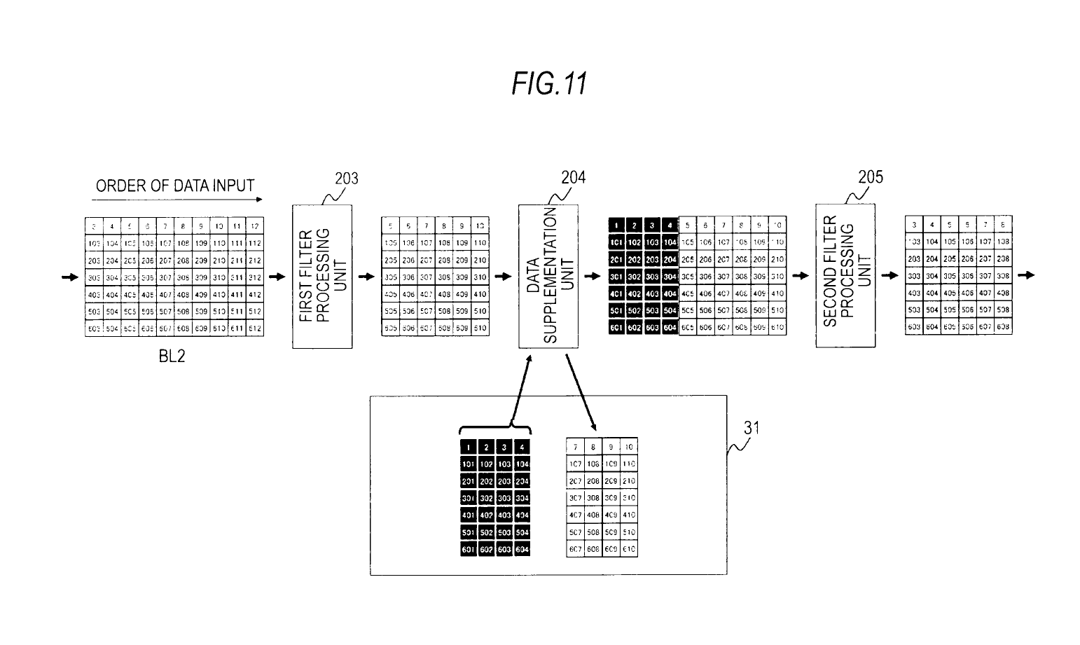

FIG. 11 shows a processing operation of the second unit of processing BL2. For example, when pixel data in the pixel locations “3” to “12” of the first line is input to the first filter processing unit 203, the first filter processing unit 203 performs filter processing with five taps and outputs pixel data after the first filter processing in the pixel locations “5” to “10”.

The data supplementation unit 204 performs processing of the first unit of processing BL1 and stores the pixel data after the first filter processing in the pixel locations “1” to “4” of the first line in the volatile memory 31. Therefore, the data supplementation unit 204 reads out the pixel data after the first filter processing in the pixel locations “1” to “4” from the volatile memory 31 and outputs the data to the second filter processing unit 205 as supplementary data. Then, the data supplementation unit 204 outputs the pixel data after the first filter processing in the pixel locations “5” to “10” to the second filter processing unit 205. Note that, in FIG. 11, the pixel locations of supplementary data are shown by solid white characters.

The second filter processing unit 205 performs second filter processing using the pixel data after the first filter processing in the pixel locations “1” to “10” supplied from the data supplementation unit 204, and outputs pixel data subjected to the first and second filter processing in the pixel locations “3” to “8”. Here, the supplementary data contains four pixels and the data of the unit of processing contains six pixels, and the filter processing is performed with five taps using the pixel data of ten pixels in total, and the output of the second filter processing unit 205 is in the number of data of the unit of processing.

As described above, the data supplementation unit 204 reads out and supplements the pixel data after the first filter processing generated in the first unit of processing BL1 from the volatile memory 31 before supplying the pixel data output from the first filter processing unit 203 to the second filter processing unit 205. Therefore, the second filter processing unit 205 may output the pixel data after the first and second filter processing in the continuous pixel locations for the output of the first unit of processing BL1.

Further, in the next unit of processing BL3, in order to output pixel data after the first and second filter processing in the pixel location “9” and the subsequent locations from the second filter processing unit 205, it is necessary to input pixel data after the first filter processing from the pixel location “7” to the second filter processing unit 205. Furthermore, the pixel data after the first filter processing from the pixel location “7” is generated by filter processing of the first filter processing unit 203 for the second unit of processing BL2. Therefore, the data supplementation unit 204 stores the pixel data after the first filter processing in the pixel locations “7” to “10” in the volatile memory 31.

The first filter processing unit 203, the data supplementation unit 204, and the second filter processing unit 205 perform processing of the second line after the processing of the first line of the second unit of processing BL2 is finished. The first filter processing unit 203 performs filter processing using pixel data in pixel locations “103” to “112” of the second line, and outputs pixel data after first filter processing in the pixel locations “105” to “110”.

The data supplementation unit 204 reads out the pixel data after the first filter processing in the pixel locations “101” to “104” of the second line stored in the volatile memory 31 and outputs the data as supplementary data to the second filter processing unit 205. Then, the data supplementation unit 204 outputs the pixel data after the first filter processing in the pixel locations “105” to “110” supplied from the first filter processing unit 203 to the second filter processing unit 205.

The second filter processing unit 205 performs filter processing using the pixel data after the first filter processing in the pixel locations “101” to “110” supplied from the data supplementation unit 204, and outputs pixel data subjected to the first and second filter processing in the pixel locations “103” to “108”.

In the next unit of processing BL3, in order to output pixel data after the first and second filter processing in the pixel location “109” and the subsequent locations from the second filter processing unit 205, it is necessary to input pixel data after the first filter processing from the pixel location “107”. Furthermore, the pixel data after the first filter processing from the pixel location “107” is generated by filter processing of the first filter processing unit 203 for the second unit of processing BL2. Therefore, the data supplementation unit 204 stores the pixel data after the first filter processing in the pixel locations “107” to “110” in the volatile memory 31.

Subsequently, the same processing is performed with respect to each line of the unit of processing BL2, and the second filter processing unit 205 outputs pixel data subjected to the first and second filter processing in the pixel locations “203” to “208”, . . . , “603” to “608”. Further, the data supplementation unit 204 stores the pixel data subjected to the first filter processing in the pixel locations “207” to “210”, . . . , “607” to “610” in the volatile memory 31.

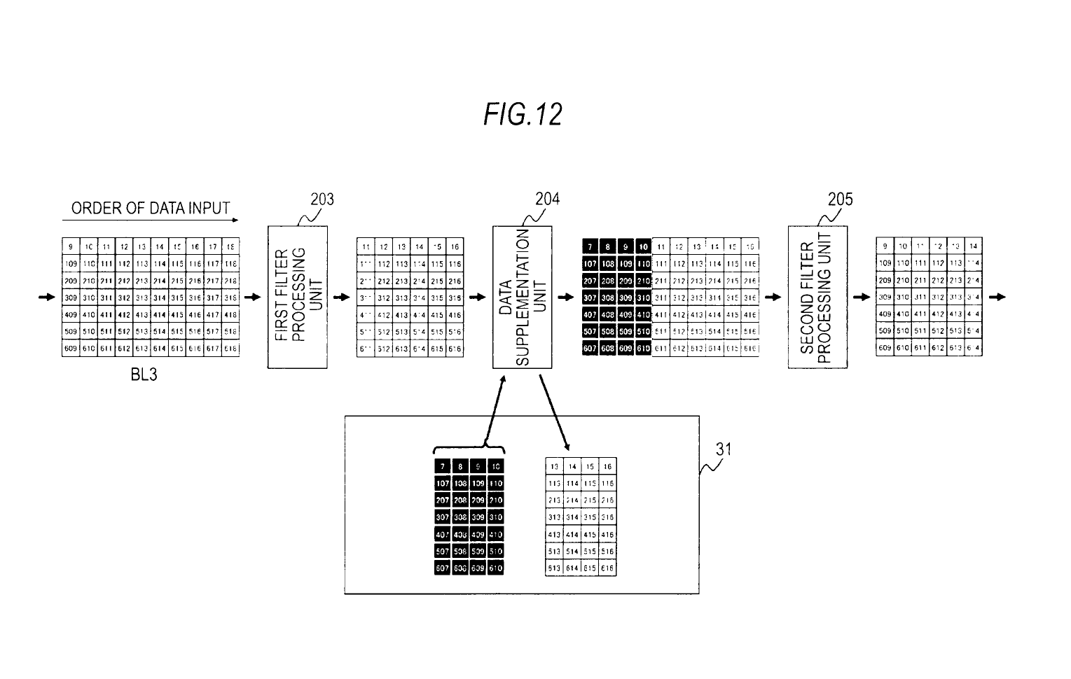

FIG. 12 shows a processing operation of the third unit of processing BL3. The same processing as that of the second unit of processing BL2 is performed on the third unit of processing BL3. When filter processing is performed on the third unit of processing BL3, the pixel data after the first filter processing in the pixel locations “7” to “10”, “107” to “110”, . . . , “607” to “610” stored in the volatile memory 31 is read out as supplementary data and supplied to the second filter processing unit 205. Further, the pixel data after the first filter processing in the pixel locations “11” to “16”, “111” to “116”, . . . , “611” to “616” from the first filter processing unit 203 is supplied to the second filter processing unit 205. Therefore, the pixel data after the first and second filter processing in the pixel locations “9” to “14”, “109” to “114”, . . . , “609” to “614” is output from the second filter processing unit 205.

Furthermore, the pixel data after the first filter processing in the pixel locations “13” to “16”, “113” to “116”, . . . , “613” to “616” is stored in the volatile memory 31 by the data supplementation unit 204. Note that, in FIG. 12, the pixel locations of supplementary data are shown by solid white characters.

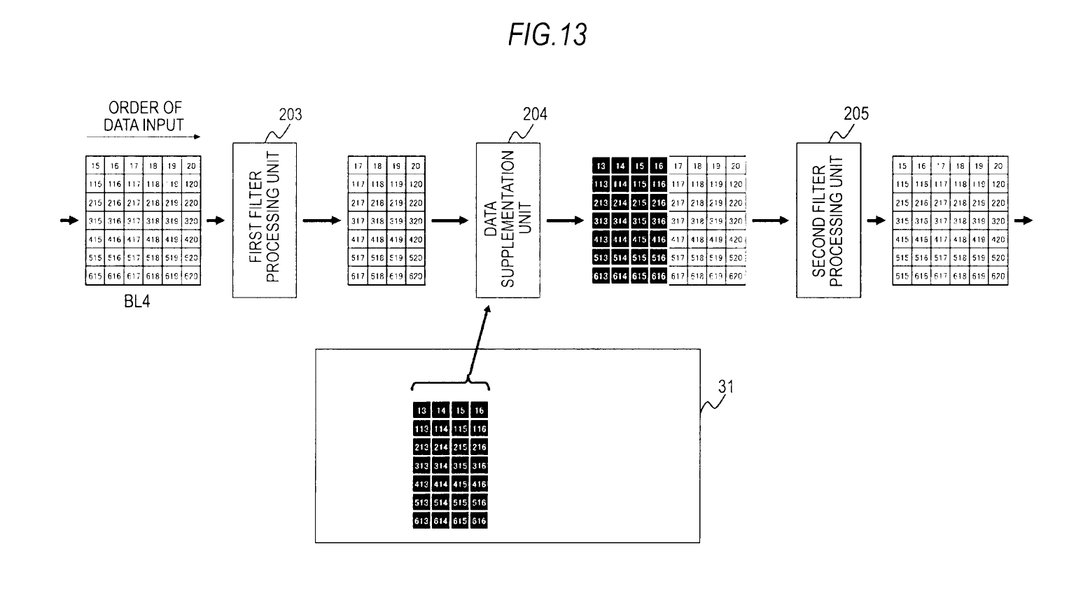

FIG. 13 shows a processing operation of the last unit of processing BL4. When pixel data in the pixel locations “15” to “20” of the first line is input to the first filter processing unit 203, the first filter processing unit 203 performs filter processing with five taps and outputs pixel data after the first filter processing in the pixel locations “17” to “20”. Note that the pixel location “20” is a location at the image end, and the first filter processing unit 203 performs pixel repeat. In FIG. 13, the pixel locations of supplementary data are shown by solid white characters.

The data supplementation unit 204 performs processing of the third unit of processing BL3, and stores pixel data after the first filter processing in the pixel locations “13” to “16” of the first line in the volatile memory 31. Therefore, the data supplementation unit 204 reads out the pixel data after the first filter processing in the pixel locations “13” to “16” from the volatile memory 31 and outputs the data to the second filter processing unit 205 as supplementary data. Then, the data supplementation unit 204 outputs the pixel data after the first filter processing in the pixel locations “17” to “20” to the second filter processing unit 205.

The second filter processing unit 205 performs second filter processing using the pixel data after the first filter processing in the pixel locations “13” to “20” supplied from the data supplementation unit 204, and outputs pixel data subjected to the first and second filter processing in the pixel locations “15” to “20”. Note that the unit performs pixel repeat at the image end.

The first filter processing unit 203, the data supplementation unit 204, and the second filter processing unit 205 perform processing of the second line after the processing of the first line of the last unit of processing BL4 is finished. The first filter processing unit 203 performs filter processing using pixel data in pixel locations “115” to “120” of the second line, and outputs pixel data after first filter processing in the pixel locations “117” to “120”. Note that the pixel location “120” is a location at the image end, and the first filter processing unit 203 performs pixel repeat.

The data supplementation unit 204 performs processing of the third unit of processing BL3 and stores the pixel data after the first filter processing in the pixel locations “113” to “116” of the second line in the volatile memory 31. Therefore, the data supplementation unit 204 reads out the pixel data after the first filter processing in the pixel locations “113” to “116” from the volatile memory 31 and outputs the data to the second filter processing unit 205 as supplementary data. Then, the data supplementation unit 204 outputs the pixel data after the first filter processing in the pixel locations “117” to “120” to the second filter processing unit 205.

The second filter processing unit 205 performs filter processing using the pixel data after the first filter processing in the pixel locations “113” to “120” supplied from the data supplementation unit 204, and outputs pixel data subjected to the first and second filter processing in the pixel locations “115” to “120”.

Subsequently, the same processing is performed with respect to each line of the unit of processing BL4, and the second filter processing unit 205 outputs pixel data subjected to the first and second filter processing in the pixel locations “215” to “220”, . . . , “615” to “620”.

In this manner, the pixel data is held and reused as supplementary data of the next unit of processing, and thereby, information processing may be efficiently performed. Further, by adjustment of the number of data of the supplementary data, the output of the second filter processing unit 205 may be in the number of units of processing.

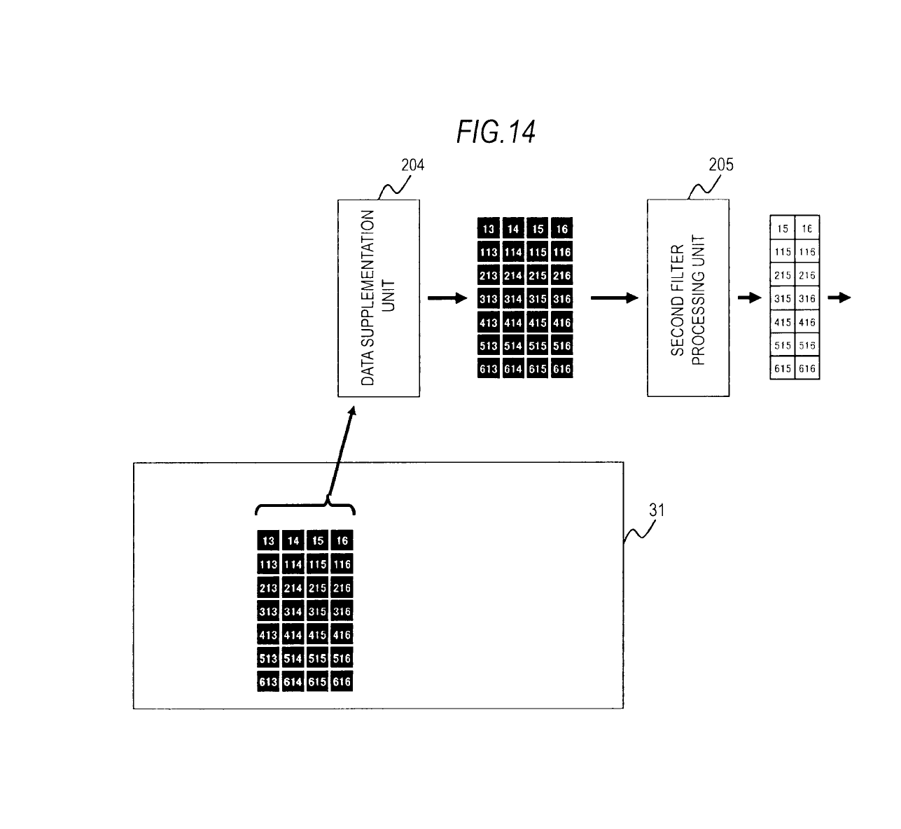

FIG. 14 shows a processing operation when the first filter processing result of the last unit of processing BL4 is held. When pixel data after the first filter processing of the respective lines of the unit of processing BL4 is stored in the volatile memory 31, the data supplementation unit 204 outputs the held pixel data to the second filter processing unit 205. For example, the last unit of processing BL4 is an area of the pixel locations “13” to “16”, “113” to “116”, . . . , “613” to “616”, processing of the third unit of processing BL3 is performed, and thereby, the first filter processing result of the unit of processing BL4 is stored in the volatile memory 31.

Therefore, the data supplementation unit 204 reads out the pixel data after the first filter processing in the pixel locations “13” to “16” from the volatile memory 31 and outputs the data to the second filter processing unit 205.

The second filter processing unit 205 performs second filter processing using the pixel data after the first filter processing in the pixel locations “13” to “16” supplied from the data supplementation unit 204, and outputs pixel data subjected to the first and second filter processing in the pixel locations “15” and “16”.

The data supplementation unit 204 and the second filter processing unit 205 perform processing of the second line after the processing of the first line of the last unit of processing BL4 is finished. The data supplementation unit 204 reads out the pixel data after the first filter processing in the pixel locations “113” to “116” from the volatile memory 31 and outputs the data to the second filter processing unit 205.

The second filter processing unit 205 performs filter processing using the pixel data after the first filter processing in the pixel locations “113” to “116” supplied from the data supplementation unit 204, and outputs pixel data subjected to the first and second filter processing in the pixel locations “115” and “116”.

Subsequently, the same processing is performed with respect to each line of the unit of processing BL4, and the second filter processing unit 205 outputs pixel data subjected to the first and second filter processing in the pixel locations “215”, “226”, . . . , “615”, and “626”.

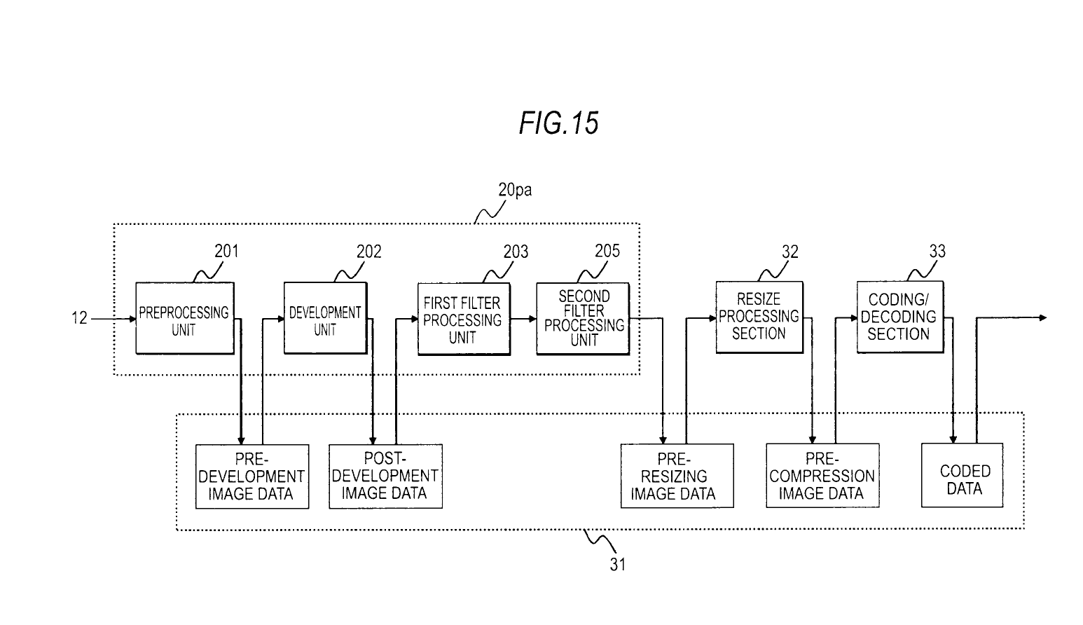

Here, for clarification of the advantages of the present technology, the operation in related art will be briefly explained. FIG. 15 shows a configuration of a camera signal processing section 20pa in related art as an example, and the first filter processing unit 203 supplies image data after filter processing to the second filter processing unit 205. The second filter processing unit 205 performs filter processing of the image data supplied from the first filter processing unit 203 and outputs it.

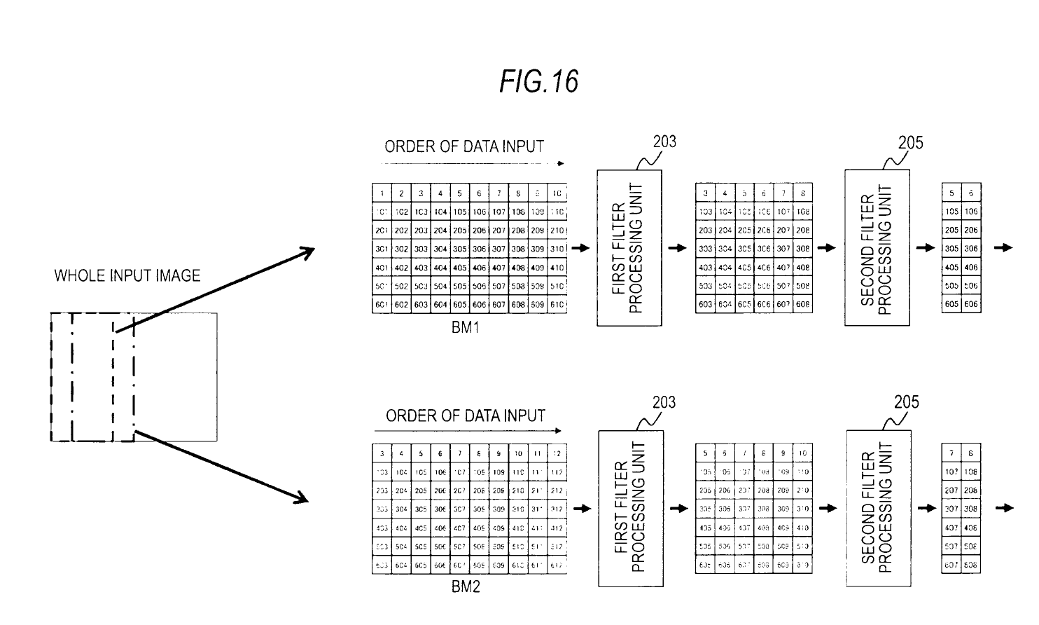

FIG. 16 shows a processing operation in related art. The first filter processing unit 203 performs filter processing using pixel data in pixel locations “1” to “10” of the first line of a unit of processing BM1 shown by a dotted line, for example, and outputs pixel data after first filter processing in the pixel locations “3” to “8” to the second filter processing unit 205.

The second filter processing unit 205 performs second filter processing using the pixel data in the pixel locations “3” to “8” supplied from the first filter processing unit 203, and outputs pixel data subjected to the first and second filter processing in the pixel locations “5” and “6”.

Subsequently, the same processing is performed, and the first filter processing unit 203 performs the first filter processing using the pixel data in the pixel locations “101” to “110”, . . . , “601” to “610” of the respective lines of the unit of processing BM1 and generates pixel data after the first filter processing in the pixel locations “103” to “108”, . . . , “603” to “608”. Further, the second filter processing unit 205 performs filter processing using the pixel data in the pixel locations “103” to “108”, . . . , “603” to “608” supplied from the first filter processing unit 203 and generates pixel data subjected to the first and second filter processing in the pixel locations “105”, “106”, . . . , “605”, and “606”.

When the processing of the unit of processing BM1 is finished, processing of the unit of processing BM2 shown by a dashed-dotted line is performed in the same manner. The first filter processing unit 203 performs first filter processing using pixel data in pixel locations “3” to “12” of the first line of the unit of processing BM2, and generates pixel data subjected to the first filter processing in the pixel locations “5” to “10” to the second filter processing unit 205.

The second filter processing unit 205 performs second filter processing using the pixel data in the pixel locations “5” to “10” supplied from the first filter processing unit 203, and outputs pixel data subjected to the first and second filter processing in the pixel locations “7” and “8”. Subsequently, the processing is performed in the same manner with respect to the respective lines, and then, pixel data subjected to the first and second filter processing in the pixel locations “7”, “8”, “107”, “108”, . . . , “607”, and “608” is output from the second filter processing unit 205. Note that, by performing the same processing while sequentially shifting the unit of processing rightward, the pixel data subjected to the first and second filter processing is output from the second filter processing unit 205.

Table 1 shows processing efficiency of information processing according to the present technology and the related art. For example, the processing efficiency refers to a ratio of the number of pixels after first and second filter processing output from the second filter processing unit 205 to the number of pixels on which read-in and write-out of pixel data are performed. In this case, in the processing in related art, pixel data for ten pixels is input to the first filter processing unit 203 and pixel data for two pixels is output from the second filter processing unit 205, and the processing efficiency is “2/10=20%”. Further, in the present technology, for example, with respect to the unit of processing BL2, pixel data for ten pixels is input to the first filter processing unit 203 and pixel data for six pixels is output from the second filter processing unit 205. Furthermore, pixel data for four pixels is written in the volatile memory 31 and pixel data for four pixels stored in the volatile memory 31 is read out. Therefore, the processing efficiency is “6/(10+4+4)=33.3%”. That is, according to the present technology, the processing efficiency may be improved.

TABLE 1

| | | Processed with data |
|---|---|---|
| | Related art | supplementation |
| Data input of first filter | 10 | 10 |
| processing unit | | |
| Supplementary data input | 0 | 4 |
| Supplementary data output | 0 | 4 |
| Data input of second | 2 | 6 |
| filter processing unit | | |
| Processing efficiency | 20% | 33.3% |

Further, by providing a memory in the data supplementation unit 204 and holding supplementary data therein, as shown in Table 2, it is not necessary to write out pixel data to an external memory or read out pixel data from an external memory. Therefore, the processing efficiency may be “6/10=60%”.

TABLE 2

| | | Processed with data |
|---|---|---|
| | Related art | supplementation |
| Data input of first filter | 10 | 10 |
| processing unit | | |
| Supplementary data input | 0 | 0 |
| Supplementary data output | 0 | 0 |
| Data input of second | 2 | 6 |
| filter processing unit | | |
| Processing efficiency | 20% | 60% |

As described above, according to the present technology, pixel data necessary for processing of the next unit of processing is held as supplementary data and filter processing is performed using the supplementary data in the next unit of processing, and thereby, the filter processing result output from the second filter processing unit 205 may be increased.

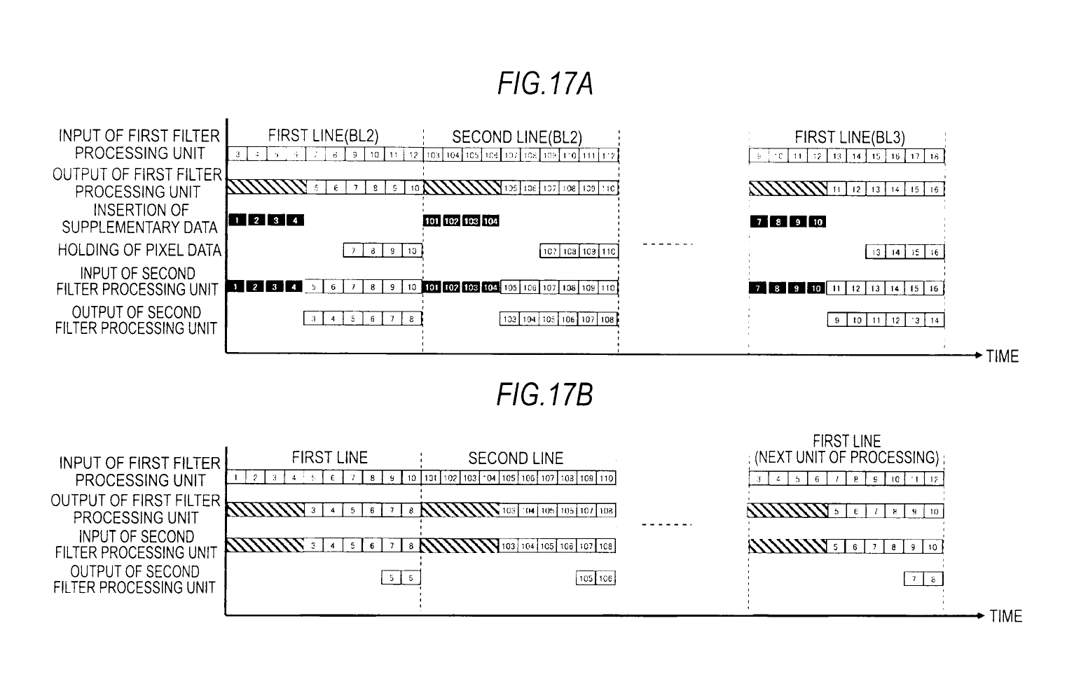

Further, according to the present technology, the information processing result may be obtained at a higher speed than that of the method in related art. FIGS. 17A and 17B show times of inputs of pixel data and outputs of pixel data after information processing. FIG. 17A shows the times of the present technology with the data supplementation unit 204, and FIG. 17B shows the times of related art without the data supplementation unit 204.

As shown in FIG. 17A, when the pixel data of the first line of the unit of processing BL2, for example, is input to the first filter processing unit 203, the supplementary data is read out from the first filter processing unit 203 and output to the second filter processing unit 205 using the period until the pixel data after filter processing is output from the first filter processing unit 203. Therefore, before the pixel data after filter processing is output in the number of taps from the first filter processing unit 203, pixel data subjected to first and second filter processing may be output from the second filter processing unit 205. On the other hand, in the case where the data supplementation unit 204 is not provided, as shown in FIG. 17B, unless the pixel data after filter processing has been output in the number of taps from the first filter processing unit 203, the pixel data subjected to first and second filter processing is not output from the second filter processing unit 205. That is, according to the present technology, more pixel data subjected to first and second filter processing may be output at earlier times than those in related art, and thus, shortening of the processing time and reduction of power consumption may be realized.

Further, the supplementary data is inserted using the period in which the pixel data after filter processing is not output from the first filter processing unit 203, and the memory for holding data is not necessarily a high-speed memory such as a resistor. Furthermore, the data supplementation unit 204 is separately provided from the filter processing units, and the data supplementation unit 204 can be used even when the filter processing unit is changed and it is not necessary to change the internal configuration of the filter processing unit.

In addition, as clearly seen from FIG. 17A, the supplementary data is used for the filter processing of the next unit of processing, and then, updated to new supplementary data. That is, it is not necessary to individually provide a memory area for supplementary data to be readout and a memory area of pixel data newly written in as supplementary data, and it is not necessary to provide many memory areas for temporarily holding the pixel data to be reused, i.e., the supplementary data.

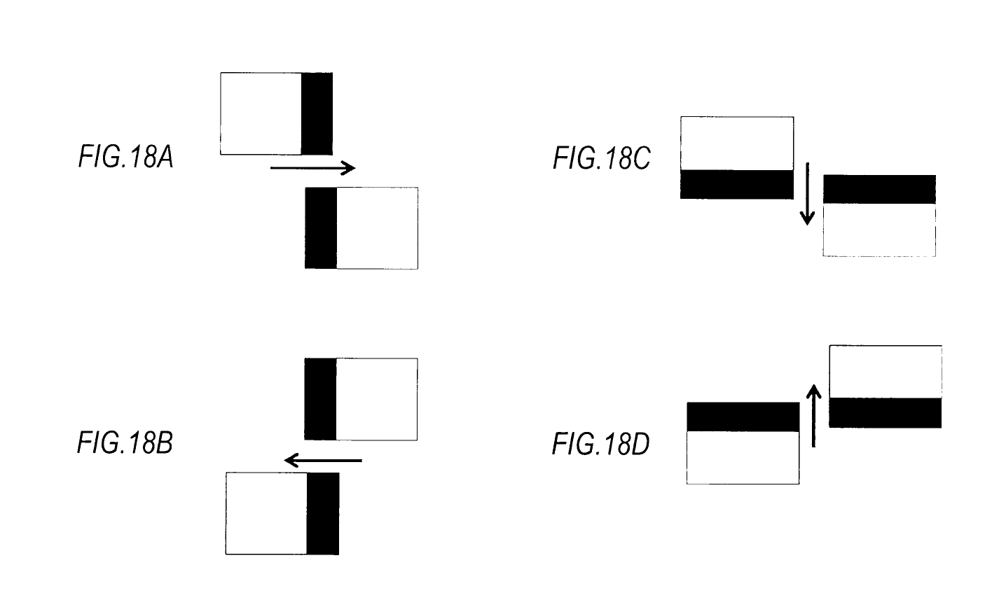

FIGS. 18A to 18D show relationships between directions in which the unit of processing is shifted and areas to which supplementary data is input and areas output as supplementary data. FIG. 18A shows the case where the unit of processing is shifted rightward indicated by an arrow as an example. When the unit of processing is shifted rightward, pixel data of an area for predetermined pixels (black area) from the right end of the unit of processing is held as supplementary data, and the held supplementary data is connected to the left end side of the unit of processing in the next unit of processing. FIG. 18B shows the case where the unit of processing is shifted leftward indicated by an arrow as an example. When the unit of processing is shifted leftward, pixel data of an area for predetermined pixels from the left end of the unit of processing is held as supplementary data, and the held supplementary data is connected to the right end side of the unit of processing in the next unit of processing. FIG. 18C shows the case where the unit of processing is shifted downward indicated by an arrow as an example. When the unit of processing is shifted downward, pixel data of an area for predetermined pixels from the lower end of the unit of processing is held as supplementary data, and the held supplementary data is connected to the upper end side of the unit of processing in the next unit of processing. FIG. 18D shows the case where the unit of processing is shifted upward indicated by an arrow as an example. When the unit of processing is shifted upward, pixel data of an area for predetermined pixels from the upper end of the unit of processing is held as supplementary data, and the held supplementary data is connected to the lower end side of the unit of processing in the next unit of processing. In this manner, by setting the supplementary data in response to the shift direction of the unit of processing, more filter output results may be obtained at earlier times regardless of the shift direction of the unit of processing as described above.

### <5. Second Configuration of Camera Signal Processing Section>

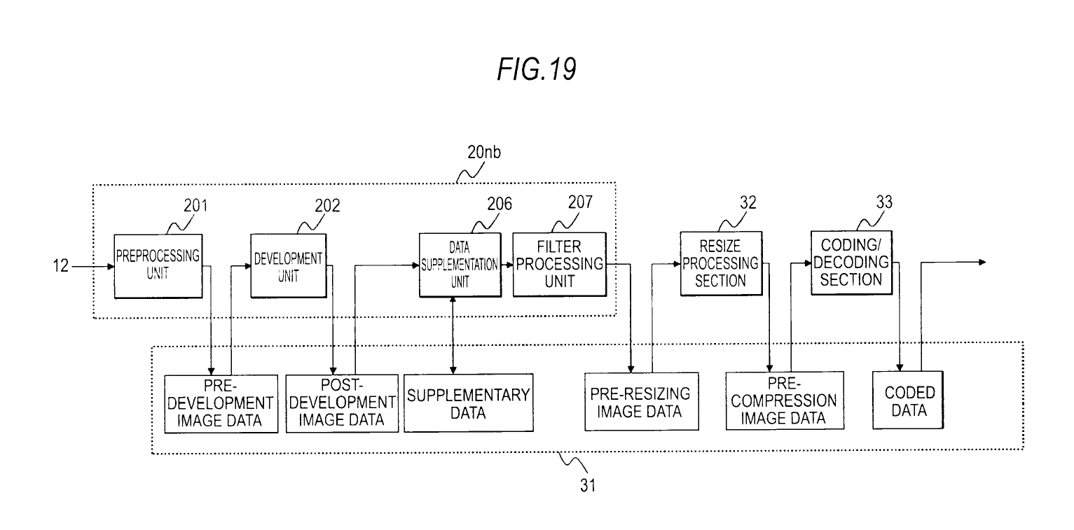

FIG. 19 shows a second configuration of the camera signal processing section. The camera signal processing section 20nb includes a preprocessing unit 201, a development unit 202, a data supplementation unit 206, and a filter processing unit 207.

The preprocessing unit 201 performs preprocessing such as analog amplification processing and A/D conversion processing of the imaging signal supplied from the imaging section 12, and stores image data (pre-development image data) subjected to the preprocessing in the volatile memory 31. The development unit 202 reads out the pre-development image data, performs correction processing such as de-mosaic processing, brightness correction, color correction, and white balance adjustment as development processing, and stores post-development image data in the volatile memory 31.

The data supplementation unit 206 has the same configuration as that of the data supplementation unit 204, and outputs the post-development image data read out from the volatile memory 31 to the filter processing unit 207. Further, the unit stores part of the read out image data in the volatile memory 31 as supplementary data. Furthermore, when filter processing of the next unit of processing is performed, the data supplementation unit 206 outputs the supplementary data stored in the volatile memory 31 to the filter processing unit 207 and outputs the post-development image data in units of processing to the filter processing unit 207.

The filter processing unit 207 is a denoising unit, for example, and performs band limitation or the like of the image data supplied from the data supplementation unit 206, eliminates noise components of the image data, and stores the denoised image data (pre-resizing image data) in the volatile memory 31.

The resize processing section 32 reads out the pre-resizing image data stored in the volatile memory 31 and performs processing of converting it into an image with desired resolution (number of pixels) or the like. The resize processing section 32 stores the post-resizing image data (pre-compression image data) in the volatile memory 31. The coding/decoding section 33 performs coding processing of the pre-compression image data and stores obtained coded data in the volatile memory 31.

### <6. Second Configuration Operation>

When the camera signal processing section 20nb reads out the post-development image data from the volatile memory 31 and performs filter processing in units of processing according to the coding processing, the memory access, or the like, the section adjusts locations of the units of processing for reduction of the number of readouts. Specifically, the image data to be processed is shifted in the opposite direction to the shift direction of the unit of processing by the pixel data necessary for obtainment of the filter processing result of the next unit of processing to be subjected to filter processing. Further, in the first unit of processing, invalid data is provided before the pixel data necessary for obtainment of the filter processing result of the next unit of processing and used as data of the unit of processing. Furthermore, the pixel data necessary for obtainment of the filter processing result of the next unit of processing is used as supplementary data. In addition, for obtainment of the filter processing results for the units of processing when filter processing is performed using the supplementary data, the image data to be processed is shifted.

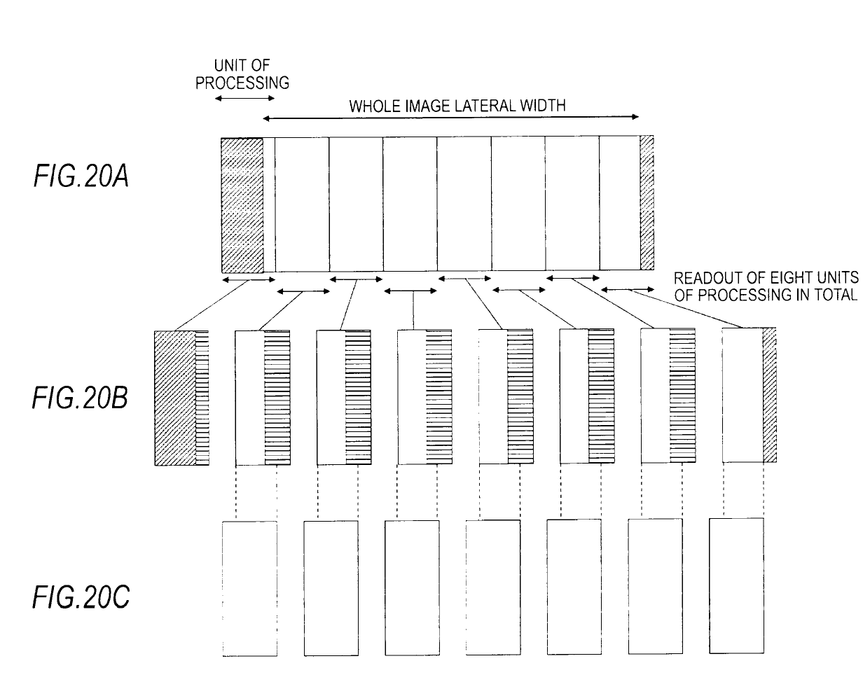

FIGS. 20A to 20C show relationships between locations of units of processing and images. When the image data is read out in units of processing, invalid data is set in areas without images (areas shown by shading).

FIG. 20A shows the case where the post-development image data is shifted with respect to the units of processing and stored in advance. FIG. 20B shows image data read out in units of processing. The areas with horizontal lines show pixel locations having pixel data used as supplementary data. FIG. 20C shows image data obtained by filter processing using the supplementary data held in the previous unit of processing and the image data read out in the next unit of processing. In FIGS. 20A to 20C, pixel data for eight units of processing is read out.

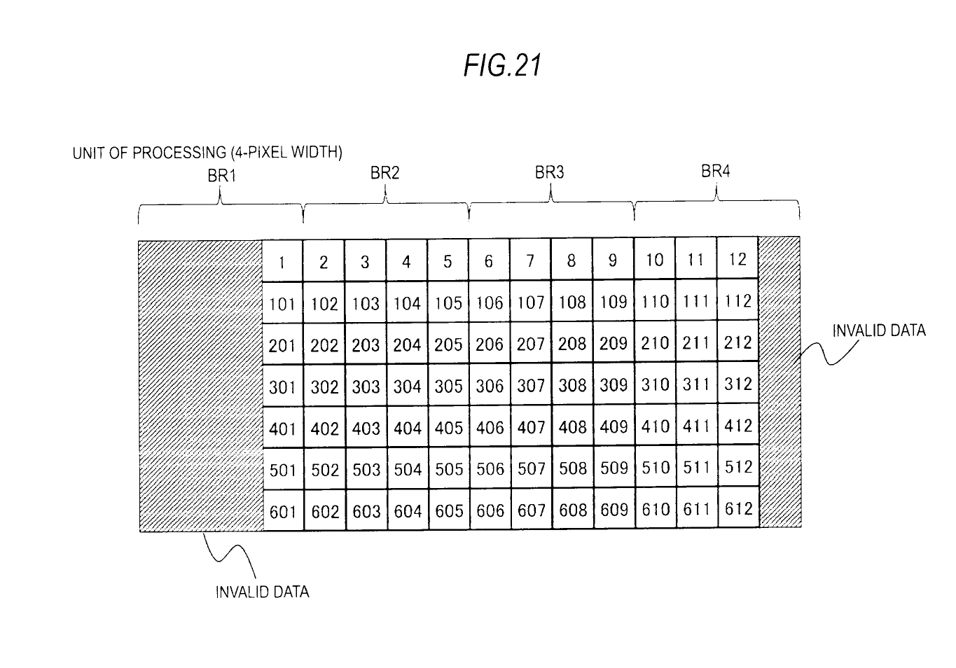

As below, an operation in the case where the location of the image is adjusted with respect to the units of processing and information processing using the supplementary data is performed thereon will be explained. Note that, for simplicity of explanation, the image size is set to 12 pixels×7 pixels as shown in FIG. 21, for example. Further, the unit of processing is a 4-pixel width, and the number of taps of the filter processing unit 207 is three.

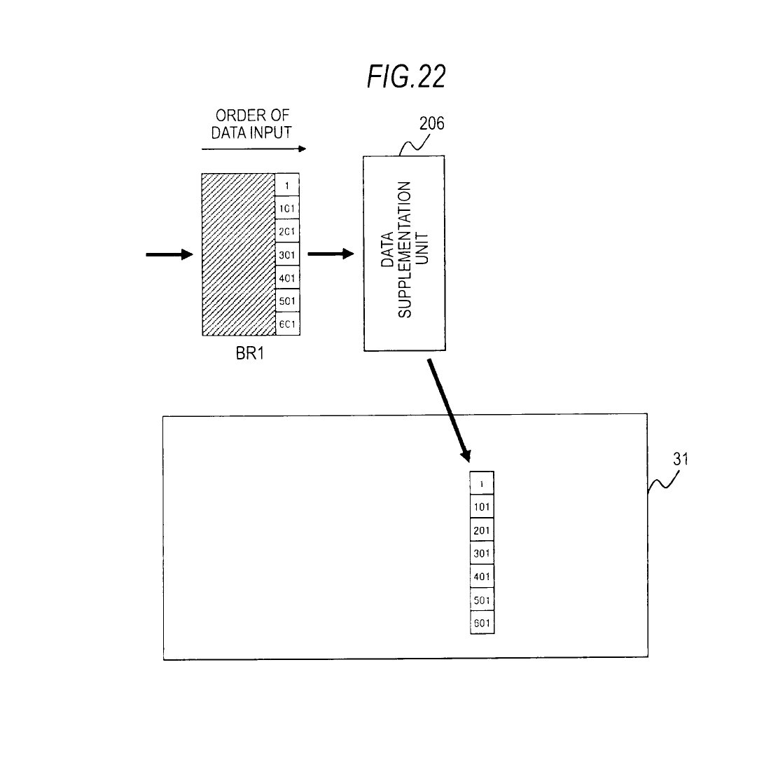

FIG. 22 shows a processing operation of the first unit of processing BR1. The data supplementation unit 206 excludes invalid data with respect to the first line of the unit of processing BR1 and stores pixel data in a pixel location “1” in the volatile memory 31. Similarly, with respect to the second and subsequent lines, the unit excludes invalid data and stores pixel data in respective pixel locations “101” to “106” in the volatile memory 31.

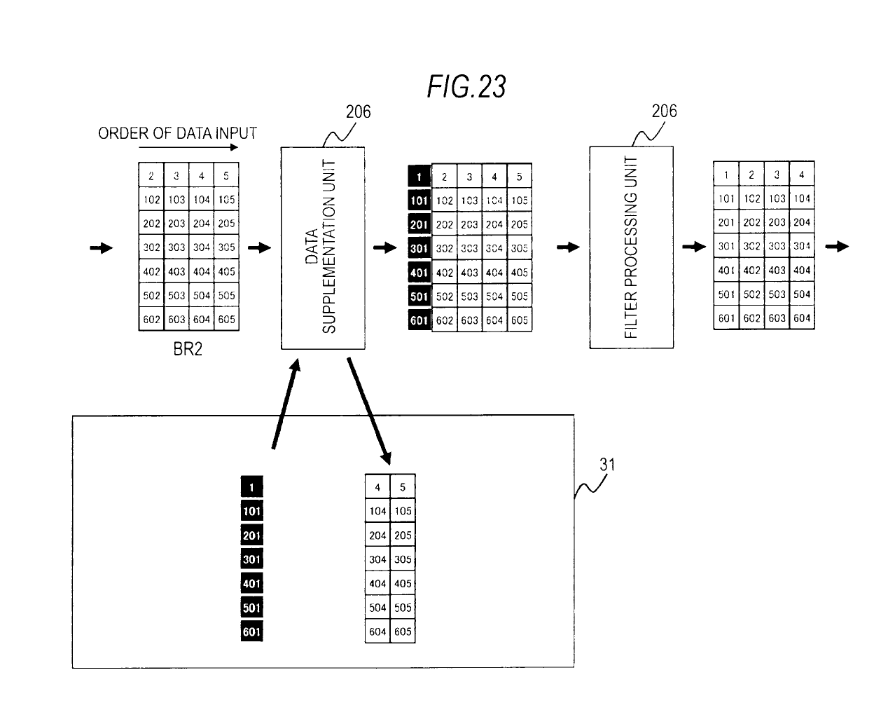

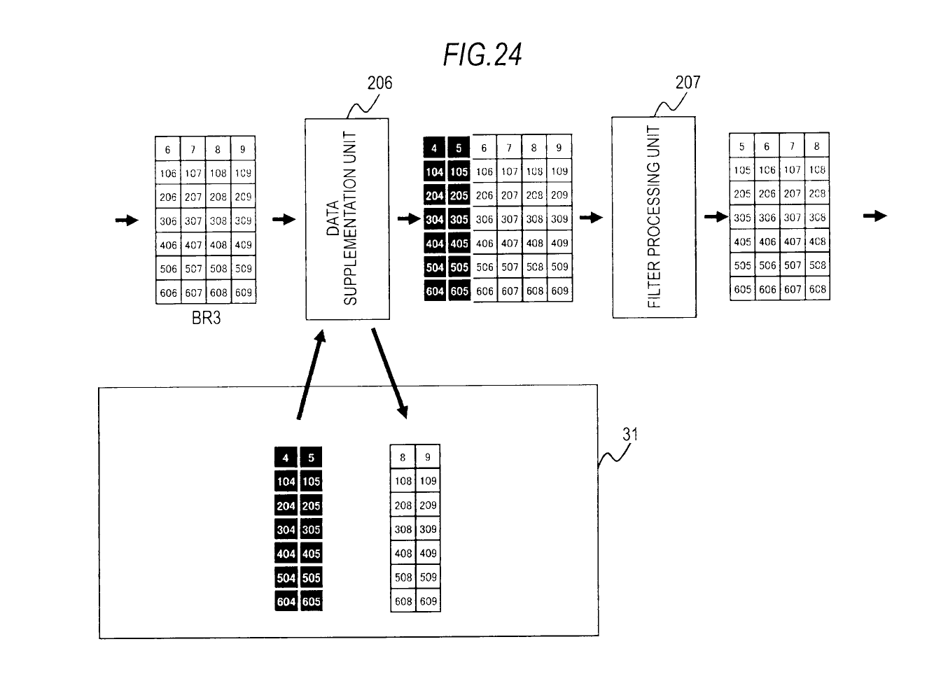

FIG. 23 shows a processing operation of the second unit of processing BR2. The data supplementation unit 206 outputs the supplementary data of the first line, i.e., the pixel data in the pixel location “1” to the filter processing unit 207, and then, outputs the pixel data in respective pixel locations “2” to “5” of the unit of processing BR2 to the filter processing unit 207. Note that, in FIG. 23, the pixel locations of supplementary data are shown by solid white characters. Further, this is the same in FIGS. 24 to 27.

The filter processing unit 207 performs filter processing with three taps using the pixel data in the pixel locations “1” to “5”, and outputs pixel data after filter processing in the pixel locations “1” to “4”. Note that the pixel location “1” is the image end, and the unit performs pixel repeat.

In the next unit of processing BR3, in order to output pixel data subjected to the filter processing in the pixel location “5” and the subsequent locations from the filter processing unit 207, it is necessary to input pixel data from the pixel location “4” to the filter processing unit 207. Further, the pixel data from the pixel location “4” has been read out in the processing of the second unit of processing BR2. Therefore, the data supplementation unit 206 stores the pixel data in the pixel locations “4” and “5” in the volatile memory 31.

The data supplementation unit 206 and the filter processing unit 207 perform processing of the second line after the processing of the first line of the second unit of processing BR2 is finished.

The data supplementation unit 206 outputs the pixel data in the pixel location “101” of the second line stored in the volatile memory 31 to the filter processing unit 207 as supplementary data. Then, the data supplementation unit 206 outputs the pixel data in the respective pixel locations “102” to “105” of the unit of processing BR2 to the filter processing unit 207.

The filter processing unit 207 performs filter processing with three taps using the pixel data in the pixel locations “101” to “105”, and outputs pixel data after filter processing in the pixel locations “101” to “104”. Note that the pixel location “101” is the image end, and the unit performs pixel repeat.

In the next unit of processing BR3, in order to output pixel data subjected to the filter processing in the pixel location “105” and the subsequent locations from the filter processing unit 207, it is necessary to input pixel data from the pixel location “104” to the filter processing unit 207. Further, the pixel data from the pixel location “104” has been read out in the processing of the second unit of processing BR2. Therefore, the data supplementation unit 206 stores the pixel data in the pixel locations “104” and “105” in the volatile memory 31.

Subsequently, the same processing is performed with respect to each line of the unit of processing BR2, and the filter processing unit 207 outputs pixel data subjected to the filter processing in the pixel locations “201” to “204”, . . . , “601” to “604”. Further, the data supplementation unit 204 stores the pixel data in the pixel locations “204”, “205”, . . . , “604”, and “605” in the volatile memory 31.

FIG. 24 shows a processing operation of the third unit of processing BR3. The data supplementation unit 206 outputs the supplementary data of the first line, i.e., the pixel data in the pixel locations “4” and “5” to the filter processing unit 207, and then, outputs the pixel data in the respective pixel locations “6” to “9” of the unit of processing BR3 to the filter processing unit 207.

The filter processing unit 207 performs filter processing with three taps using the pixel data in the pixel locations “4” to “9”, and outputs pixel data after filter processing in the pixel locations “5” to “8”.

In the next unit of processing BR4, in order to output pixel data subjected to the filter processing in the pixel location “9” and the subsequent locations from the filter processing unit 207, it is necessary to input pixel data from the pixel location “8” to the filter processing unit 207. Further, the pixel data from the pixel location “8” has been read out in the processing of the third unit of processing BR3. Therefore, the data supplementation unit 206 stores the pixel data in the pixel locations “8” and “9” in the volatile memory 31.

The data supplementation unit 206 and the filter processing unit 207 perform processing of the second line after the processing of the first line of the third unit of processing BR3 is finished.

The data supplementation unit 206 outputs the pixel data in the pixel locations “104” and “105” of the second line stored in the volatile memory 31 to the filter processing unit 207 as supplementary data. Then, the data supplementation unit 206 outputs the pixel data in the respective pixel locations “106” and “109” of the unit of processing BR3 to the filter processing unit 207.

The filter processing unit 207 performs filter processing with three taps using the pixel data in the pixel locations “104” to “109”, and outputs pixel data after filter processing in the pixel locations “105” to “108”. That is, the filter processing unit 207 performs filter processing with three taps using the supplementary data for two pixels and read out pixel data for four pixels, and thereby, may output a filter result for four pixels equal to the unit of processing.

In the next unit of processing BR4, in order to output pixel data subjected to the filter processing in the pixel location “109” and the subsequent locations from the filter processing unit 207, it is necessary to input pixel data from the pixel location “108” to the filter processing unit 207. Further, the pixel data from the pixel location “108” has been read out in the processing of the third unit of processing BR3. Therefore, the data supplementation unit 206 stores the pixel data in the pixel locations “108” and “109” in the volatile memory 31.

Subsequently, the same processing is performed with respect to each line of the unit of processing BR3, and the filter processing unit 207 outputs pixel data subjected to the filter processing in the pixel locations “205” to “208”, . . . , “605” to “608”. Further, the data supplementation unit 204 stores the pixel data in the pixel locations “208”, “209”, . . . , “608”, and “609” in the volatile memory 31.

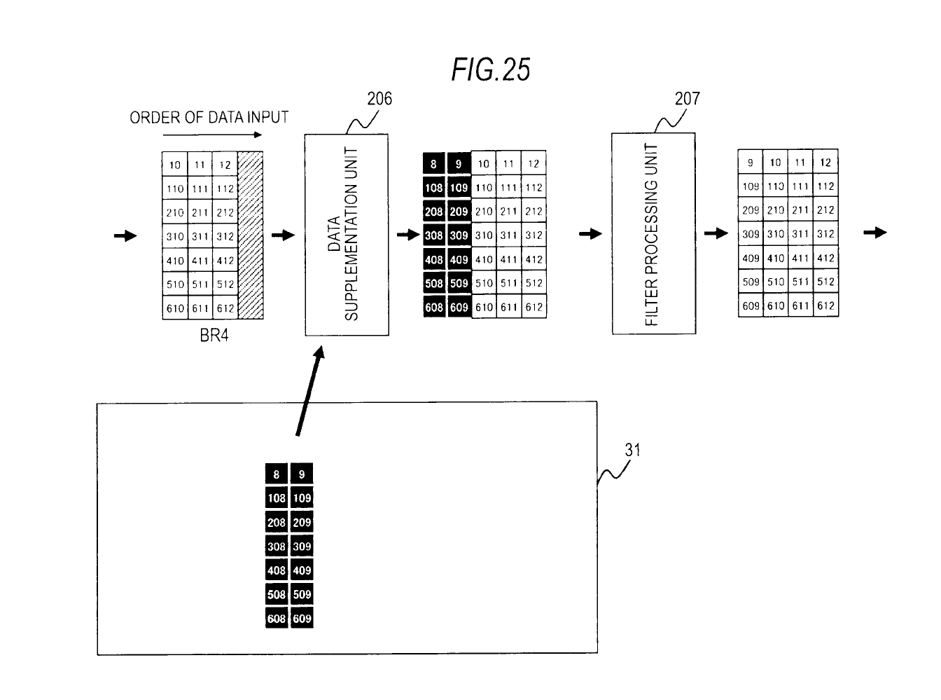

FIG. 25 shows a processing operation of the last unit of processing BR4. The data supplementation unit 206 outputs the supplementary data of the first line, i.e., the pixel data in the pixel locations “8” and “9” to the filter processing unit 207, and then, outputs the pixel data in the respective pixel locations “10” to “12” of the unit of processing BR4 to the filter processing unit 207.

The filter processing unit 207 performs filter processing with three taps using the pixel data in the pixel locations “8” to “12”, and outputs pixel data after filter processing in the pixel locations “9” to “12”. Note that the pixel location “12” is a location at the image end, and the filter processing unit 207 performs pixel repeat.

The data supplementation unit 206 and the filter processing unit 207 perform processing of the second line after the processing of the first line of the unit of processing BR4 is finished.

The data supplementation unit 206 outputs the pixel data in the pixel locations “108” and “109” of the second line stored in the volatile memory 31 to the filter processing unit 207 as supplementary data. Then, the data supplementation unit 206 outputs the pixel data in the respective pixel locations “110” and “112” of the unit of processing BR3 to the filter processing unit 207.

The filter processing unit 207 performs filter processing with three taps using the pixel data in the pixel locations “108” to “112”, and outputs pixel data after filter processing in the pixel locations “109” to “112”.

Subsequently, the same processing is performed with respect to each line of the unit of processing BR4, and the filter processing unit 207 outputs pixel data subjected to the filter processing in the pixel locations “209” to “212”, . . . , “609” to “612”.

As described above, by performing readout of pixel data, holding of pixel data, and supply of supplementary data, processing results may be obtained even when the number of readouts of units of processing is reduced. Further, by adjustment of the number of pixel data to be held, the processing results may be output in units of processing.

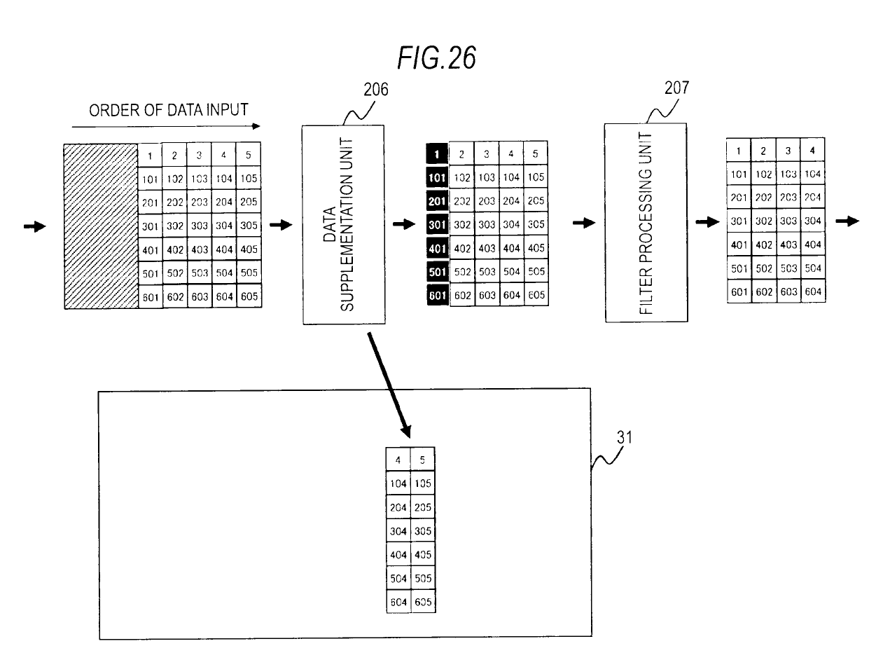

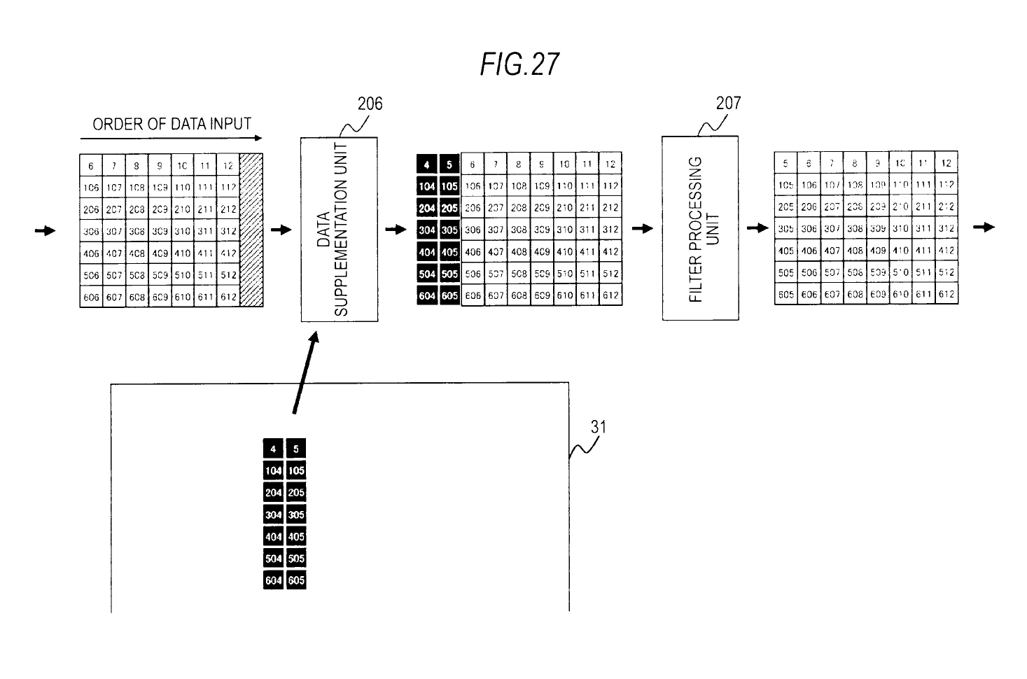

FIGS. 26 and 27 show the case where the unit of processing is doubled to an 8-pixel width. In this case, in processing of the first unit of processing, as shown in FIG. 26, pixel data after filter processing in pixel locations “1” to “4”, . . . , “601” to “604” is output from the filter processing unit 207. Further, the data supplementation unit 206 stores pixel data in the pixel locations “4”, “5”, “104”, “105”, . . . , “604”, “605” in the volatile memory 31.

Then, in processing of the second unit of processing, as shown in FIG. 27, filter processing is performed using the pixel data in the pixel locations “4”, “5”, “104”, “105”, . . . , “604”, “605” and the pixel data of the second unit of processing. Therefore, pixel data after filter processing in the pixel locations “5” to “12”, . . . , “605” to “612” is output from the filter processing unit 207.

Further, as shown in FIG. 21, when an image is stored in the volatile memory 31, the storage location is shifted and invalid data is provided in parts with no image. In the storage of the image in this manner, only by reading out image data in unit of processing from the volatile memory 31 and supplying it to the data supplementation unit 206, supplementary data necessary for information processing of the next unit of processing may be easily held.

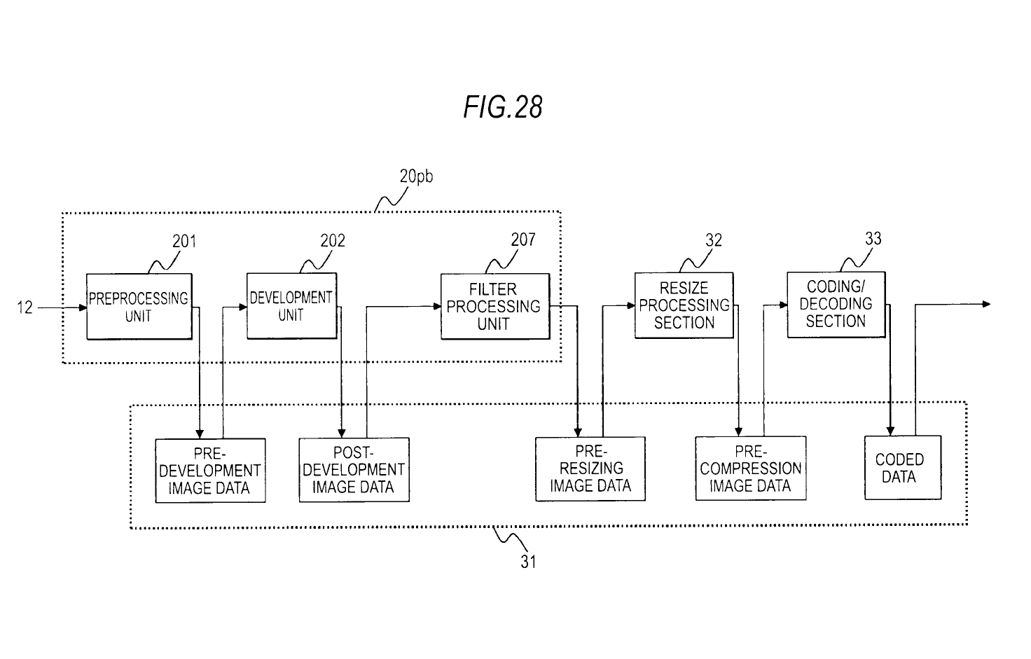

Here, for clarification of the advantages of the present technology, the operation in related art will be briefly explained. FIG. 28 shows a camera signal processing section 20pb in related art as an example, and the filter processing unit 207 performs filter processing sequentially using post-development image data read out from the volatile memory 31 and outputs it.

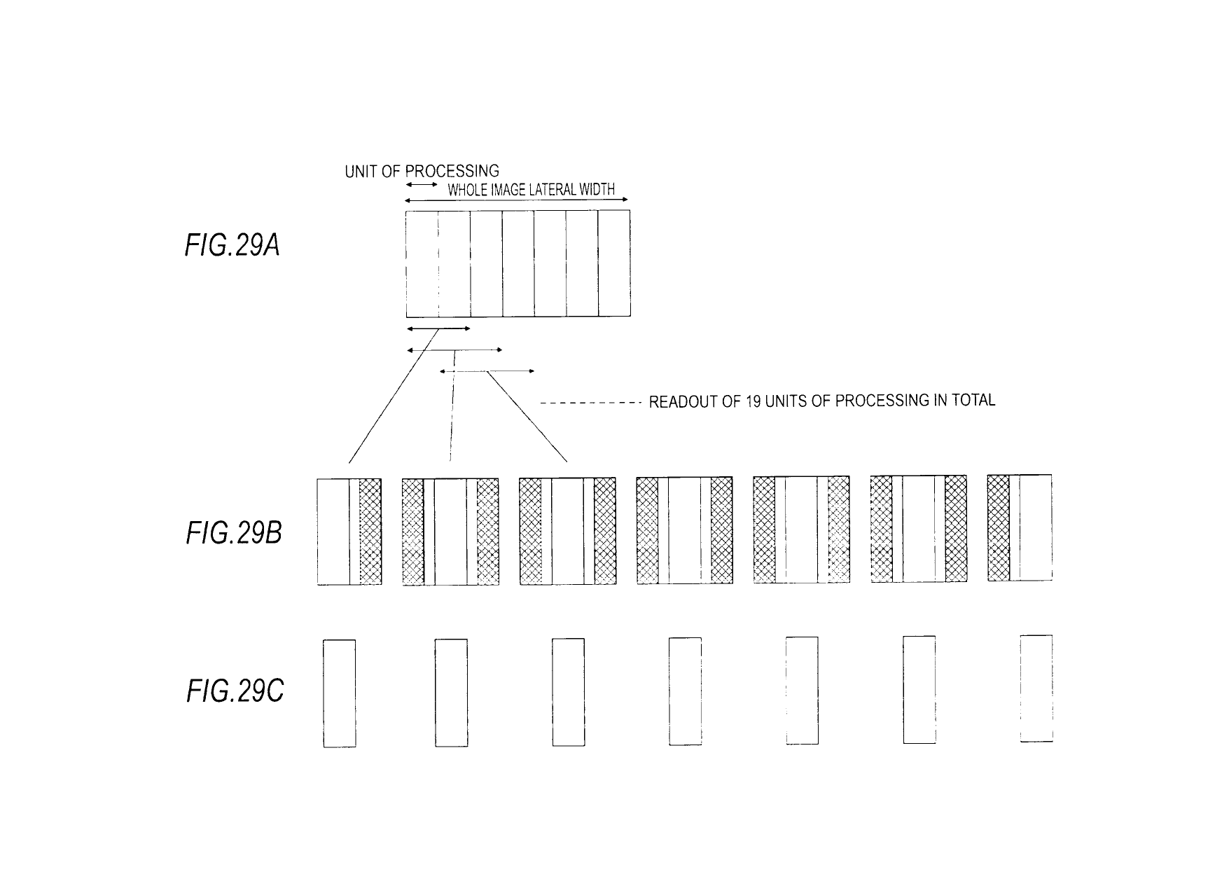

FIGS. 29A to 29C show relationships between locations of units of processing and images. The units of processing are set so that the start location of the image and the start location of the unit of processing may coincide as shown in FIG. 29A. FIG. 29B shows image data read out for using the output from the filter processing unit 207 as units of processing. Note that the cross-hatching areas show pixel locations of pixel data not used for filter processing. FIG. 29C shows outputs from the filter processing unit 207.

As described above, to output image data for the first unit of processing from the filter processing unit 207, extra data in response to the number of taps is necessary, and it is necessary to read out image data for two units of processing. Further, to output image data for the second unit of processing from the filter processing unit 207, extra data in response to the number of taps is necessary both on the right and left sides, and it is necessary to read out image data for three units of processing. Similarly, to output image data for the read out units of processing from the filter processing unit 207, it is necessary to read out image data for the readout units of processing including extra data in response to the number of taps. Note that, in FIGS. 20A to 200, it is necessary to read out pixel data for eight units of processing, and, in FIGS. 29A to 29C, it is necessary to read out pixel data for 19 units of processing.

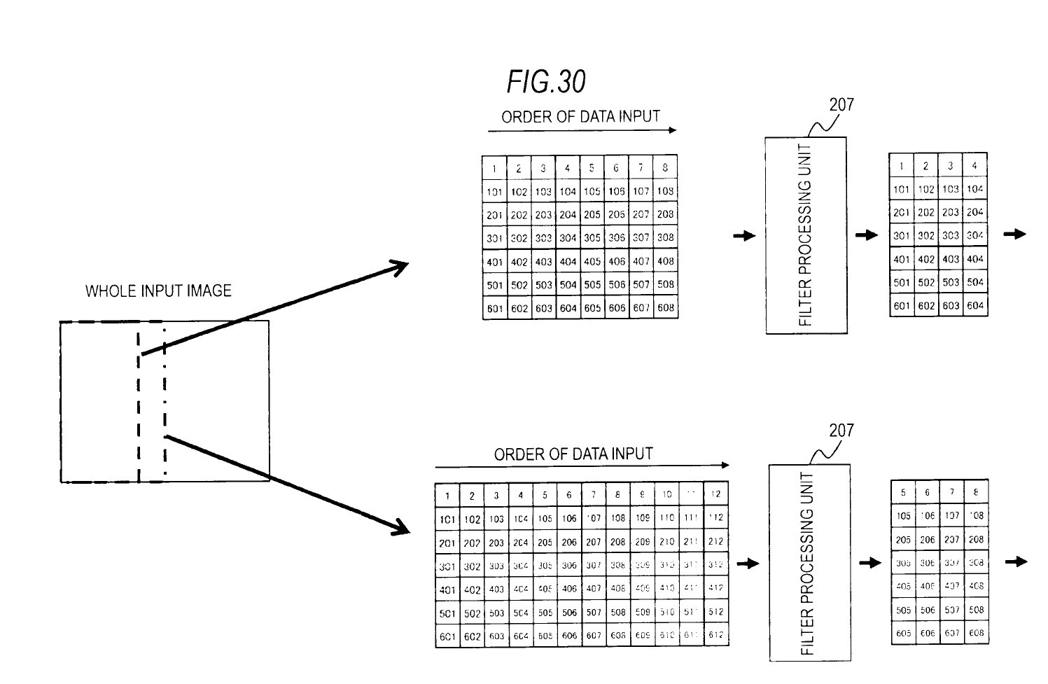

FIG. 30 shows a processing operation in related art in the case where the unit of processing is a four-pixel width, the number of taps of the filter processing unit 207 is three. For example, image data in an area for two units of processing shown by a dotted line, i.e., pixel data in pixel locations “1” to “8” is read out and supplied to the filter processing unit 207, and thereby, pixel data after filter processing in the pixel locations “1” to “4” may be output from the filter processing unit 207. Similarly, by supplying pixel data in pixel locations “101” to “108”, . . . , “601” to “608” to the filter processing unit 207, pixel data after filter processing in the pixel locations “101” to “104”, . . . , “601” to “604” may be output from the filter processing unit 207.

Then, image data in an area for three units of processing shown by a dashed-dotted line, i.e., pixel data in pixel locations “1” to “12” is read out and supplied to the filter processing unit 207, and thereby, pixel data after filter processing in the pixel locations “5” to “8” may be output from the filter processing unit 207. Similarly, by supplying pixel data in pixel locations “101” to “112”, . . . , “601” to “612” to the filter processing unit 207, pixel data after filter processing in the pixel locations “105” to “108”, . . . , “605” to “608” may be output from the filter processing unit 207.

Table 3 shows processing efficiency of filter processing according to the present technology and the related art. For example, the processing efficiency refers to a ratio of the number of pixels after filter processing output from the filter processing unit 207 to the number of pixels on which read-in and write-out of pixel data are performed. Here, in the case where a filter processing result of the second unit of processing is obtained, in the filter processing in related art, pixel data for 12 pixels is input to the filter processing unit 207 and pixel data for four pixels is output, the processing efficiency is “4/10=33.3%”. Further, in the present technology, supplementary data for two pixels and pixel data for four pixels of the unit of processing is supplied to the filter processing unit 207 and pixel data for four pixels is output. Furthermore, pixel data for two pixels is written in the volatile memory 31 as supplementary data. Therefore, the processing efficiency is “4/(4+2+2)=50%”. That is, according to the present technology, the processing efficiency may be improved.

TABLE 3

| | | Processed with data |
|---|---|---|
| | Related art | supplementation |
| Data input | 12 | 4 |
| Supplementary data input | 0 | 2 |
| Supplementary data output | 0 | 2 |
| Filter data output | 4 | 4 |
| Processing efficiency | 33.33% | 50% |

Further, by providing a memory in the data supplementation unit 204 and holding supplementary data therein, it is not necessary to write out supplementary data to an external memory or read out supplementary data from an external memory. Therefore, the processing efficiency may be “4/4=100%” as shown in Table 4.

TABLE 4

| | | Processed with data |
|---|---|---|
| | Related art | supplementation |
| Data input | 12 | 4 |
| Supplementary data input | 0 | 0 |
| Supplementary data output | 0 | 0 |
| Filter data output | 4 | 4 |
| Processing efficiency | 33.33% | 100% |

As described above, according to the second configuration of the present technology, the number of readouts of image data in units of processing may be reduced. Therefore, reduction of the memory band, shortening of the processing time, and reduction of power consumption may be realized. Further, in the case where processing is performed using one filter processing unit, as has been explained using FIGS. 26 and 27, both inputs and outputs can be in multiple numbers of units of processing in the memory or the like, and the memory band and the processing time may be further reduced.

Further, according to the present technology, the information processing result may be obtained at a higher speed than that of the method in related art.

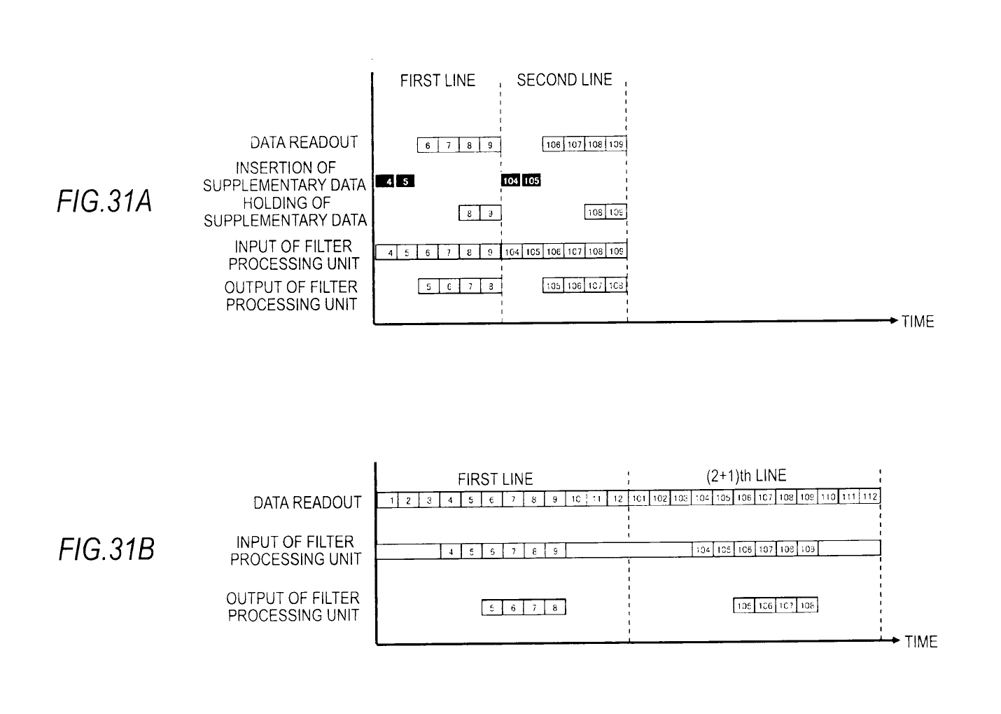

FIGS. 31A and 31B show times of inputs of pixel data and outputs of pixel data after filter processing. FIG. 31A shows times of the present technology with the data supplementation unit 206, and FIG. 31B shows times of related art without the data supplementation unit 206. Further, FIGS. 31A and 31B show cases where filter output results of the third unit of processing are obtained.

As shown in FIG. 31A, for example, before pixel data of the unit of processing in pixel locations “6” to “9” is read out, pixel data in pixel locations “4” and “5” is supplied as supplementary data from the volatile memory 31 to the filter processing unit 207 by the data supplementation unit 206. Therefore, the pixel data of the third unit of processing is supplied to the filter processing unit 207 and reaches the number of taps, pixel data subjected to filter processing may be output from the filter processing unit 207. On the other hand, in the related art configuration without the data supplementation unit 206, as shown in FIG. 31B, pixel data of the unit of processing in pixel locations “1” to “4” is read out, and then, pixel data of the unit of processing in pixel locations “5” to “8” is read out. Therefore, unless the pixel data in the pixel locations “4” to “6” is input to the filter processing unit 207, it may be impossible that the filter result of the pixel location “5” is output. That is, according to the present technology, the pixel data subjected to filter processing may be output at earlier times than those in related art.

Further, as clearly seen from FIG. 31A, the supplementary data is used for filter processing of the next unit of processing, and then, updated to new supplementary data. That is, it is unnecessary to individually provide the memory area of supplementary data to be read out and the memory area of pixel data to be written as new supplementary data, and thus, it is not necessary to provide many memory areas for temporarily hold the pixel data to be reused, i.e., the supplementary data.

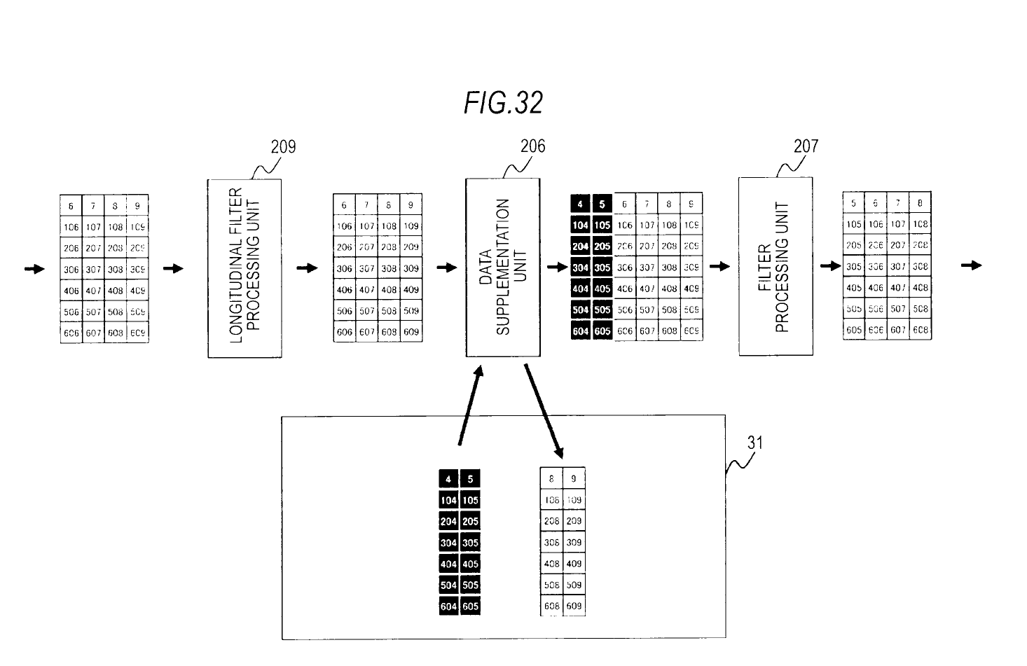

FIG. 32 shows a processing operation when a filter processing unit 209 that performs filter processing only in the longitudinal direction is provided at the upstream of the data supplementation unit 206. Since the supplementation of pixel data is performed with respect to the lateral direction, if extra pixel data is not necessary in the lateral direction, lateral widths of inputs of the filter processing unit 209 and the data supplementation unit 206 in the longitudinal direction are equal. Therefore, even when the filter processing unit 209 that performs filter processing only in the longitudinal direction is provided, processing may be performed in the same manner as that in the case without the filter processing unit that performs filter processing only in the longitudinal direction as described above.

<7. Operation in combination of First Configuration Operation and Second Configuration Operation>

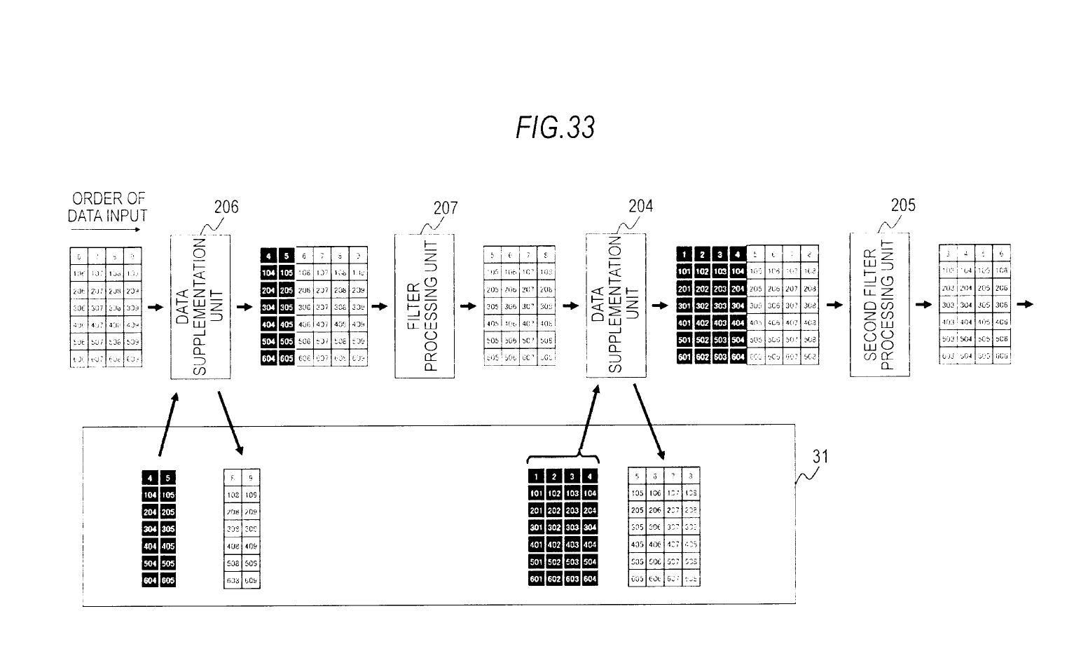

The above described first configuration operation and second configuration operation may be performed in combination. FIG. 33 shows the case where the first configuration operation and the second configuration operation are combined.

The data supplementation unit 206 supplies image data read out in units of processing to the filter processing unit 207 (corresponding to the first filter processing unit 203). Further, the data supplementation unit 206 supplies supplementary data to the filter processing unit 207 before supplying the image data read out in units of processing to the filter processing unit 207. Furthermore, the data supplementation unit 206 holds part of the read out image data as supplementary data.

The filter processing unit 207 performs filter processing of the image data supplied from the data supplementation unit 206, and outputs the image data after filter processing to the data supplementation unit 204.

The data supplementation unit 204 supplies the held supplementary data to the second filter processing unit 205, and then, outputs the image data subjected to filter processing in the filter processing unit 207 to the second filter processing unit 205. Further, the data supplementation unit 204 holds the image data subjected to filter processing in the filter processing unit 207 as supplementary data.

The second filter processing unit 205 performs filter processing of the image data supplied from the data supplementation unit 204, and outputs the image data subjected to filter processing.

By performing the processing in the above described manner, idle times for filter processing may be reduced, and both inputs and outputs may be in units of processing (units of four pixels in FIG. 33). Therefore, reduction of the memory band, shortening of the processing time, reduction of power consumption, etc. may be realized.

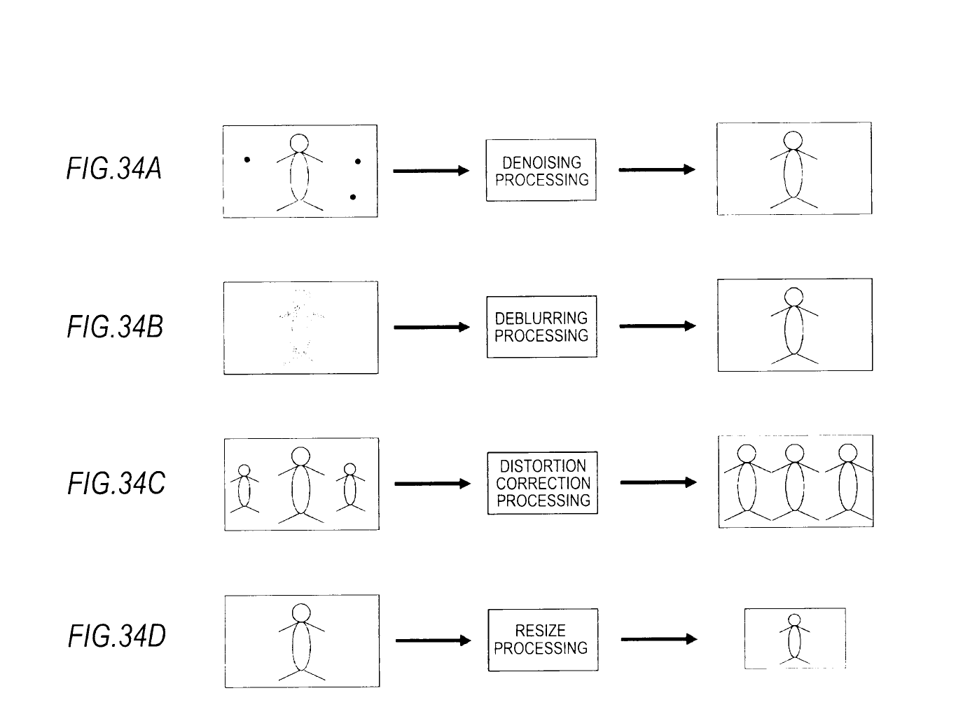

Note that, in the above described embodiment, the cases where denoising shown in FIG. 34A and deblurring processing shown in FIG. 34B are performed as filter processing have been exemplified, however, distortion correction processing shown in FIG. 34C, resize processing shown in FIG. 34D, or the like may be performed.

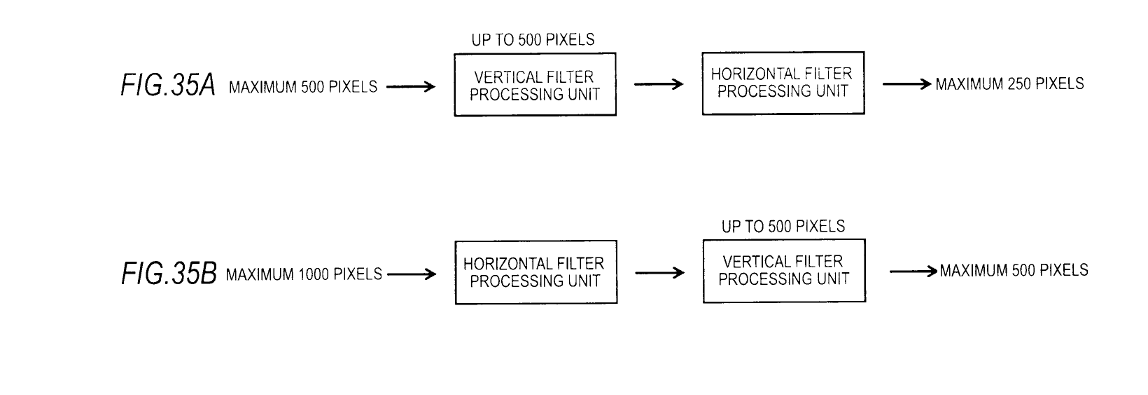

Further, in the case where there are constraints of the lateral width in vertical filter processing, in related art, it is desirable to perform horizontal processing in reduction processing in priority. For example, as shown in FIGS. 35A and 35B, in the case where the lateral width of the vertical filter processing unit is up to 500 pixels, if vertical filter processing is first performed in reduction to a half as shown in FIG. 35A, the processable lateral width of the image is the image of 500 pixels at the maximum. However, if horizontal filter processing is first performed in reduction to a half as shown in FIG. 35B, vertical filter processing is performed after the lateral width of the image is reduced to a half, and an image up to 1000 pixels may be processed. However, according to the present technology, it is only necessary to hold the supplementary data and it is not necessary to specifically place a limitation on the order of horizontal filter processing and vertical filter processing, and filter processing having a high degree of freedom may be performed.

Furthermore, the case where filter processing of image data is performed has been explained in the above described embodiment, however, not limited to the image data, but other data may be used as long as the data is for filter processing using data around the data to be processed. For example, the present technology may be applied to the case where filter processing of sound data is performed. In addition, information processing is not limited to filter processing. For example, the present technology may be applied to the case such as coding and decoding processing of performing information processing of changing the order of data in a certain range around the data of interest.

The series of processing that has been explained in the specification may be executed by hardware, software, or a combined configuration of them. In the case where processing by software is executed, a program in which a processing sequence is recorded is installed in a memory within a computer incorporated into dedicated hardware and executed. Alternatively, a program may be installed in a general-purpose computer that can execute various kinds of processing and executed.

For example, the program may be recorded in a hard disc or a ROM (Read Only Memory) as a recording medium in advance. Alternatively, the program may be temporarily or permanently stored (recorded) in a removable recording medium such as a flexible disc, a CD-ROM (Compact Disc Read Only Memory), an MO (Magneto optical) disc, a DVD (Digital Versatile Disc), a magnetic disc, or a semiconductor memory card. The removable recording medium may be provided as the so-called package software.

Or, the program may not only be installed from a removable recording medium to a computer but also be transferred from a download site through wired or wireless connection via a network such as LAN (Local Area Network) or the Internet. In the computer, thus transferred program may be received and installed in a recording medium of a hard disc therein or the like.

The present technology should not be limitedly interpreted to the above described embodiment. The embodiment of the present technology has disclosed the present technology in the form of exemplification, and it is clear that a person who skilled in the art may alter or substitute the embodiment without departing from the scope of the present technology. That is, to evaluate the gist of the present technology, the appended claims should be taken into consideration.

The present technology may also be implemented as the following configurations.

(1) An information processing device including

an information processing unit that performs information processing sequentially using data with respect to each unit of processing, and obtains information processing results using a predetermined number of data in the order of processing with reference to data to be processed in the information processing of the data, and

a data supplementation unit that extracts data contained in the predetermined number for obtaining the information processing result of the data of the next unit of processing to be subjected to the information processing and holds the data as supplementary data in the data with respect to each unit of processing supplied to the information processing unit, and allows the information processing unit to perform the information processing sequentially using the held supplementary data and the data of the next unit of processing to be subjected to the information processing.

(2) The information processing device according to (1), wherein the data supplementation unit extracts the supplementary data to obtain the information processing results for the units of processing if the information processing is performed in the information processing unit sequentially using the supplementary data and the data of the next unit of processing to be subjected to the information processing.

(3) The information processing device according to (1) or (2), wherein a first information processing unit and a second information processing unit are provided,

the second information processing unit performs information processing using an information processing result of the first information processing unit, and

the data supplementation unit extracts the data contained in the predetermined number for obtaining the information processing result of the next data to be subjected to the information processing in the second information processing unit from the information processing results output from the first information processing unit and holds the data as supplementary data, and outputs the held supplementary data to the second information processing unit using a period until the information processing result of the data of the next unit of processing is output from the first information processing unit.

(4) The information processing device according to any one of (1) to (3), wherein the data to be processed is shifted in an opposite direction to a shift direction of the unit of processing by the data contained in the predetermined number for obtaining the information processing result of the next data to be subjected to the information processing, and invalid data is provided before the data contained in the predetermined number in the first unit of processing.

(5) The information processing device according to any one of (1) to (4), further including a memory from which data is read out in units of processing,

wherein locations of data to be subjected to information processing are shifted and stored in the memory so that the supplementary data may be provided after the invalid data in the data of the first unit of processing.

(6) The information processing device according to any one of (1) to (5), wherein, after the supplementary data is used for the information processing of the next unit of processing, the data supplementation unit rewrites new pixel data as supplementary data.

(7) The information processing device according to any one of (1) to (6), wherein the data is image data.

In the information processing device, the information processing method, and the program, information processing is performed sequentially using data with respect to each unit of processing, and a predetermined number of data in the order of processing with reference to data to be processed is used in the information processing of the data. Further, the data contained in the predetermined number for obtaining an information processing result of the data of the next unit of processing to be subjected to the information processing is held as supplementary data, and information processing is performed sequentially using the held supplementary data and the data of the next unit of processing to be subjected to the information processing. Therefore, information processing using data to be processed may be performed with high efficiency.

Accordingly, the present technology may be applied to electronic equipment that performs information processing using data in a certain range around data to be processed, for example, various kinds of electronic equipment including a digital still camera, a digital video camera, computer equipment, a game machine, television equipment, telephone equipment, a PDA, an image reproduction device, an image recording device, a navigation device, a cellular phone terminal device, a printer, an electronic book reproduction device, a communication device, etc.

The present disclosure contains subject matter related to that disclosed in Japanese Priority Patent Application JP 2011-127184 filed in the Japan Patent Office on Jun. 7, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
an information processing unit that performs information processing sequentially using data with respect to each unit of processing, and obtains information processing results using a predetermined number of data in the order of processing with reference to data to be processed in the information processing of the data; and
a data supplementation unit that extracts data contained in the predetermined number for obtaining the information processing result of the data of the next unit of processing to be subjected to the information processing and holds the data as supplementary data in the data with respect to each unit of processing supplied to the information processing unit, and allows the information processing unit to perform the information processing sequentially using the held supplementary data and the data of the next unit of processing to be subjected to the information processing.

2. The information processing device according to claim 1, wherein the data supplementation unit extracts the supplementary data to obtain the information processing results for the units of processing if the information processing is performed in the information processing unit sequentially using the supplementary data and the data of the next unit of processing to be subjected to the information processing.

3. The information processing device according to claim 1, wherein a first information processing unit and a second information processing unit are provided,
the second information processing unit performs information processing using an information processing result of the first information processing unit, and
the data supplementation unit extracts the data contained in the predetermined number for obtaining the information processing result of the next data to be subjected to the information processing in the second information processing unit from the information processing results output from the first information processing unit and holds the data as supplementary data, and outputs the held supplementary data to the second information processing unit using a period until the information processing result of the data of the next unit of processing is output from the first information processing unit.

4. The information processing device according to claim 1, wherein the data to be processed is shifted in an opposite direction to a shift direction of the unit of processing by the data contained in the predetermined number for obtaining the information processing result of the next data to be subjected to the information processing, and invalid data is provided before the data contained in the predetermined number in the first unit of processing.

5. The information processing device according to claim 4, further including a memory from which data is read out in units of processing,
wherein locations of data to be subjected to information processing are shifted and stored in the memory so that the supplementary data may be provided after the invalid data in the data of the first unit of processing.

6. The information processing device according to claim 1, wherein, after the supplementary data is used for the information processing of the next unit of processing, the data supplementation unit updates the supplementary data with new supplementary data.

7. The information processing device according to claim 1, wherein the data is image data.

8. An information processing method comprising:
performing information processing sequentially using data with respect to each unit of processing, and obtaining information processing results using a predetermined number of data in the order of processing with reference to data to be processed in the information processing of the data; and
supplementing data by extracting data contained in the predetermined number for obtaining the information processing result of the data of the next unit of processing to be subjected to the information processing and holding the data as supplementary data in the data with respect to each unit of processing used in the information processing, and allows in the information processing to perform the information processing sequentially using the held supplementary data and the data of the next unit of processing to be subjected to the information processing.

9. A program allowing a computer to execute information processing, comprising:
an information processing procedure of performing information processing sequentially using data with respect to each unit of processing, and obtaining information processing results using a predetermined number of data in the order of processing with reference to data to be processed in the information processing of the data; and
a data supplementing procedure of extracting data contained in the predetermined number for obtaining the information processing result of the data of the next unit of processing to be subjected to the information processing and holding the data as supplementary data in the data with respect to each unit of processing used in the information processing procedure, and allows in the information processing procedure to perform the information processing sequentially using the held supplementary data and the data of the next unit of processing to be subjected to the information processing.
